(19) United States
(12) Patent Application Publication
(10) Pub. No.: US 2026/0001103 A1
(43) Pub. Date: Jan. 1, 2026

(54) CLASSIFYING OF STREAM OF CONTIGUOUS MATERIALS

(71) Applicant: Sortera Technologies Inc., Markle, IN (US)

(72) Inventors: Matthew Gevers, Fort Wayne, IN (US); Jacob John Berry, JR., Uniondale, IN (US); Kyle Thomas Kokjer Hartley, Hutto, TX (US); Nicholas Xavier Horrell, Fort Wayne, IN (US); Manual Gerardo Garcia, JR., Austin, TX (US); Kelly K. Kordzik, Briarcliff, TX (US)

(73) Assignee: Sortera Technologies Inc., Markle, IN (US)

(21) Appl. No.: 19/248,323

(22) Filed: Jun. 24, 2025

Related U.S. Application Data
(60) Provisional application No. 63/664,643, filed on Jun. 26, 2024.

(51) Int. Cl. B07B 13/00; B07B 13/04; B07B 13/18

(52) U.S. Cl. CPC B07B 13/003; B07B 13/04; B07B 13/18

(57) ABSTRACT

Systems and methods for classifying, evaluating, and sorting materials within a contiguous stream of materials. Segments of the material stream are classified and evaluated, whether such segments make up a whole material piece or a portion of a material piece. The sorting is then performed as a function of the classifications and evaluations.

This application claims priority to U.S. Provisional Patent Application Ser. No. 63/664,643, which is hereby incorporated by reference herein.

### TECHNOLOGY FIELD

The present disclosure relates in general to the classifying and/or sorting of materials, and in particular, to the classifying and/or sorting of a moving stream of contiguous materials.

### BACKGROUND INFORMATION

The classifying and sorting of certain materials (e.g., scrap or municipal waste pieces) can be challenging due to their lack of uniformity in shape and size, which makes it difficult to convey such materials on a conveyor system at uniform distances (spacing) between each other. Often, such materials may be spaced too far apart, leading to a reduction in throughput of the overall classifying/sorting process. Or, such materials are conveyed in groups, or clumps, i.e., spaced too close together, making it more difficult for the classifying technology and mechanism to accurately identify and discern between each of the materials, which results in a reduction of the sorting accuracy between different classes of materials. Such clumps of materials also make it difficult for a sorting apparatus to accurately separate the materials from each other.

### BRIEF DESCRIPTION OF THE DRAWINGS

FIG. 1 illustrates a schematic of a material handling system that contains elements that can be utilized for classifying and/or sorting of material pieces in accordance with certain embodiments of the present disclosure.

FIG. 2 illustrates a table listing chemical compositions for common aluminum alloys.

FIG. 3 illustrates a table listing a chemical composition for an exemplary aluminum alloy to be produced in accordance with certain embodiments of the present disclosure.

FIG. 4 illustrates a flowchart diagram configured in accordance with certain embodiments of the present disclosure for producing a collection of material pieces possessing a predetermined specific aggregate chemical composition, which can be implemented within embodiments of the material handling system of FIG. 1 or the classifying/sorting system of FIG. 12.

FIG. 5 illustrates a flowchart diagram configured for determining sizes of material pieces in accordance with certain embodiments of the present disclosure, which can be implemented within embodiments of the material handling system of FIG. 1 or the classifying/sorting system of FIG. 12.

FIG. 6 shows visual images of exemplary cast aluminum scrap pieces.

FIG. 7 shows visual images of exemplary aluminum extrusion scrap pieces.

FIG. 8 shows visual images of exemplary wrought aluminum scrap pieces.

FIG. 9 illustrates a flowchart diagram of a system and process for classifying/sorting material pieces configured in accordance with certain embodiments of the present disclosure, which can be implemented within embodiments of the material handling system of FIG. 1 or the classifying/sorting system of FIG. 12.

FIG. 10 illustrates a flowchart diagram of a system and process for classifying/sorting material pieces configured in accordance with certain embodiments of the present disclosure, which can be implemented within embodiments of the material handling system of FIG. 1 or the classifying/sorting system of FIG. 12.

FIG. 11 illustrates a block diagram of a data processing system configured in accordance with embodiments of the present disclosure.

FIG. 12 illustrates a simplified schematic diagram of a classifying/sorting system configured in accordance with certain embodiments of the present disclosure.

FIG. 13 schematically illustrates positioning/depositing of material pieces on a conveyor system in a substantially contiguous stream.

FIG. 14 schematically illustrates classifying and analyzing of a contiguous stream of materials for sorting from a conveyor system.

FIG. 15 illustrates a flowchart diagram configured in accordance with certain embodiments of the present disclosure.

### DETAILED DESCRIPTION

Various detailed embodiments of the present disclosure are disclosed herein. However, it is to be understood that the disclosed embodiments are merely exemplary of the disclosure, which may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to employ various embodiments of the present disclosure.

As used herein, “chemical element” means a chemical element of the periodic table of chemical elements, including chemical elements that may be discovered after the filing date of this application. As used herein, a “material” may include a solid composed of a compound or mixture of one or more chemical elements, wherein the complexity of a compound or mixture may range from being simple to complex (all of which may also be referred to herein as a material having a specific “chemical composition”).

Within this disclosure, the terms “scrap,” “scrap piece,” “material,” “material piece,” “material scrap piece,” and “piece” may be used interchangeably. In certain contexts, reference to a material may be with respect to a “segment” of a material piece, as that term is described herein. As used herein, a material piece or scrap piece referred to as having a metal alloy composition is a metal alloy having a specific chemical composition that distinguishes it from other metal alloys.

Classifications of materials may include specific types of metals (ferrous and nonferrous), metal alloys, plastics (including, but not limited to, PCB, HDPE, UHMWPE, and various colored plastics), rubber, foam, glass (including, but not limited to, borosilicate or soda lime glass, and various colored glass), ceramics, paper, cardboard, Teflon, PE, bundled wires, insulation covered wires, rare earth elements, leaves, wood, plants, parts of plants, textiles, bio-waste, packaging, electronic waste, printed circuit boards, batteries, accumulators, scrap pieces from end-of-life (“EOL”) objects (e.g., vehicles, aircraft, appliances, etc.), mining, construction, and demolition waste, crop wastes, forest residues, purpose-grown grasses, woody energy crops, microalgae, urban food waste, food waste, hazardous chemical and biomedical wastes, construction debris, farm wastes, biogenic items, non-biogenic items, objects with a specific carbon content, any other objects that may be found within municipal solid waste, and any other objects, items, or materials disclosed herein, including further types or classes of any of the foregoing that can be distinguished from each other by one or more sensor systems, including but not limited to, any of the sensor technologies disclosed herein.

As used herein, a “specific aggregate chemical composition” means the composition of chemical elements and their relative percentages by weight (wt %) within a collection or group of individual, separate material pieces. (Note that the percentage by weight (or weight percentage) is also referred to as the mass fraction, which is the percentage of the mass of a specific chemical element within a material or substance to the total mass of the material or substance.) For example, if a collection of individual pieces of metal alloys were melted together, the resultant “melt” would possess a chemical composition equivalent to the specific aggregate chemical composition. As referenced herein, a “melt” is when selected material pieces are melted together, and a composition analysis is performed on the melted together material pieces to determine the percentages (e.g., percentages by weight) of the various chemical elements existing within the melt.

As well known in the industry, a “polymer” is a substance or material composed of very large molecules, or macromolecules, composed of many repeating subunits. A polymer may be a natural polymer found in nature or a synthetic polymer. “Multilayer polymer films” are composed of two or more different compositions. The layers are at least partially contiguous and preferably, but optionally, coextensive. As used herein, the terms “plastic,” “plastic piece,” and “piece of plastic material” (all of which may be used interchangeably) refer to any object that includes or is composed of a polymer composition of one or more polymers and/or multilayer polymer films.

As used herein, the term “chemical signature” refers to a unique pattern (e.g., fingerprint spectrum), as would be produced by one or more analytical instruments, indicating the presence of one or more specific elements or molecules (including polymers) in a sample. The elements or molecules may be organic and/or inorganic. Such analytical instruments include any of the sensor systems disclosed herein. In accordance with embodiments of the present disclosure, one or more sensor systems disclosed herein may be configured to produce a chemical signature of a material piece (e.g., a plastic piece).

As used herein, a “fraction” refers to any specified combination of organic and/or inorganic elements or molecules, polymer types, plastic types, polymer compositions, chemical signatures of plastics, physical characteristics of the plastic piece (e.g., color, transparency, strength, melting point, density, shape, size, manufacturing type, uniformity, reaction to stimuli, etc.), etc., including any and all of the various classifications and types of plastics disclosed herein. Non-limiting examples of fractions are one or more different types of plastic pieces that contain: LDPE plus a relatively high percentage of aluminum; LDPE and PP plus a relatively low percentage of iron; PP plus zinc; combinations of PE, PET, and HDPE; any type of red-colored LDPE plastic pieces; any combination of plastic pieces excluding PVC; black-colored plastic pieces; combinations of #3-#7 type plastics that contain a specified combination of organic and inorganic molecules; combinations of one or more different types of multi-layer polymer films; combinations of specified plastics that do not contain a specified contaminant or additive; any types of plastics with a melting point greater than a specified threshold; any thermoset plastic of a plurality of specified types; specified plastics that do not contain chlorine; combinations of plastics having similar densities; combinations of plastics having similar polarities; plastic bottles without attached caps or vice versa.

As used herein, the term “predetermined” refers to something (e.g., a parameter, measurement, length, width, time period interval, etc.) that has been established or decided in advance (e.g., by a user of a system or process disclosed herein).

“Spectral imaging” is imaging that uses one or more bands across the electromagnetic spectrum. While an ordinary visual camera captures light across three wavelength bands in the visible spectrum, red, green, and blue (“RGB”), spectral imaging can encompass a wide variety of techniques that include but go beyond RGB. For example, spectral imaging may use infrared, visible, ultraviolet, and/or x-ray spectrums, or some combination of the above. Spectral data, or spectral image data, is a digital data representation of a spectral image produced by spectral imaging. Spectral imaging may include the acquisition of spectral data in visible and non-visible bands simultaneously, illumination from outside the visible range, or the use of optical filters to capture a specific spectral range. It is also possible to capture hundreds of wavelength bands for each pixel in a spectral image. As used herein, the term “image data packet” refers to a packet of digital data pertaining to a captured spectral image of all or a portion (e.g., segment) of an individual material piece as the case may be.

As used herein, the terms “classify,” “identify,” “select,” and “recognize” and the terms “classification,” “identification,” “selection,” and “recognition” and any derivatives of the foregoing, may be utilized interchangeably. As used herein, to “classify” a material piece, or a segment of a material piece, is to determine (i.e., identify) a type or class of material or materials to which the material piece, or a segment of a material piece, belongs (or at least should belong according to sensed (measured) characteristics of that material piece or segment). For example, in accordance with certain embodiments of the present disclosure, a sensor system (as further described herein) may be configured to capture (or collect) and analyze any type of information for classifying materials, which classifications can be utilized within a material handling system to selectively sort materials as a function of a set of one or more sensed (measured) physical and/or chemical characteristics (e.g., which may be user-defined), including but not limited to, color, texture, hue, shape, brightness, weight, density, chemical composition, size, uniformity, manufacturing type, chemical signature, predetermined fraction, radioactive signature, transmissivity to light, sound, or other signals, and reaction to stimuli such as various fields, including emitted and/or reflected electromagnetic radiation (“EM”) of the materials. As used herein, “manufacturing type” refers to the type of manufacturing process by which the material piece was manufactured, such as a metal part having been formed by a wrought process, having been cast (including, but not limited to, expendable mold casting, permanent mold casting, injection mold casting, and powder metallurgy), having been forged, a material removal process, etc.

The types or classes (i.e., classifications) of materials may be user-definable and not limited to any known classification of materials. The granularity of the types or classes may range from very coarse to very fine. For example, the types or classes may include plastics, ceramics, glasses, metals, and other materials, where the granularity of such types or classes is relatively coarse; different metals and metal alloys such as, for example, zinc, copper, brass, chrome plate, and aluminum, where the granularity of such types or classes is finer; or between specific subclasses of metal alloys (e.g., between different aluminum alloys or plastic types), where the granularity of such types or classes is relatively fine. Thus, the types or classes may be configured to distinguish between materials of significantly different compositions such as, for example, plastics and metal alloys, or to distinguish between materials of substantially similar or almost identical chemical composition such as, for example, different subclasses of metal alloys or plastics. It should be appreciated that the systems and methods discussed herein may be applied to identify/classify materials for which the chemical composition is completely unknown before being classified.

As referred to herein, a “conveyor system” may be any known piece of mechanical handling equipment that moves materials from one location to another, including, but not limited to, an aero-mechanical conveyor, automotive conveyor, conveyor belt, belt-driven live roller conveyor, bucket conveyor, chain conveyor, chain-driven live roller conveyor, drag conveyor, dust-proof conveyor, electric track vehicle system, flexible conveyor, gravity conveyor, free-fall (vertical) conveyor, gravity skatewheel conveyor, lineshaft roller conveyor, motorized-drive roller conveyor, overhead I-beam conveyor, overland conveyor, pharmaceutical conveyor, plastic belt conveyor, pneumatic conveyor, screw or auger conveyor, spiral conveyor, tubular gallery conveyor, vertical conveyor, vibrating conveyor, and wire mesh conveyor. “Singulation” (and derivatives of such term) refers to aligning materials into single lines as they move in a conveyor system.

The systems and methods described herein according to certain embodiments of the present disclosure receive a mixture of a plurality of material pieces, wherein at least one material piece within this mixture includes a chemical composition (e.g., a metal alloy composition, a chemical signature) different from one or more other material pieces, and/or at least one material piece within this mixture was manufactured differently from one or more other materials, and/or at least one material piece within this mixture is distinguishable (e.g., visually discernible characteristics or features, different chemical signatures, etc.) from other material pieces, and the systems and methods are configured to accordingly identify/classify/sort this material piece (or segment of a material piece as further described herein). Embodiments of the present disclosure may be utilized to sort any types or classes of materials, or fractions, as defined herein.

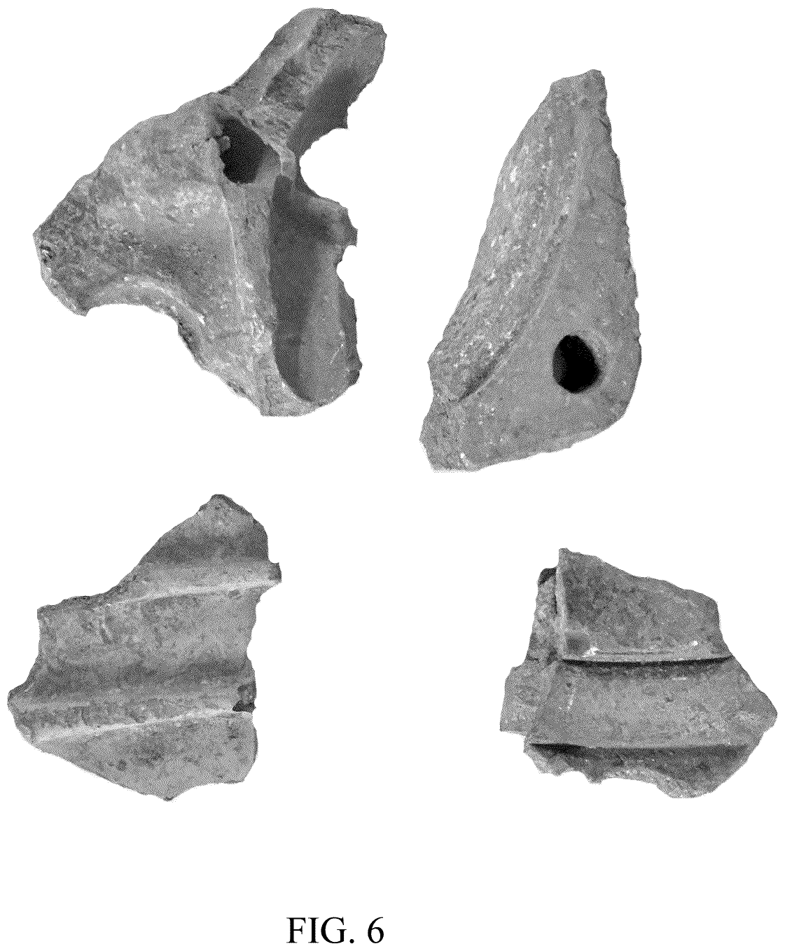

It should be noted that the material pieces to be sorted may have irregular shapes and/or sizes (e.g., see FIGS. 6-8 and 13), which provides challenges in positioning or depositing of such material pieces at consistent predetermined spacing in a conveyor system. For example, objects (e.g., EOL vehicles, appliances, and/or aircraft) may have been previously processed through some sort of shredding mechanism that chops up the objects into such irregularly shaped and sized pieces (producing material pieces (also referred to as scrap pieces)), which may then be positioned or deposited onto a conveyor system as described herein. Or the material pieces may be composed of any other types of materials that have irregular sizes and/or shapes, such as materials commonly found in municipal solid waste (“MSW”), including, but not limited to, different types of plastics (e.g., plastic bottles).

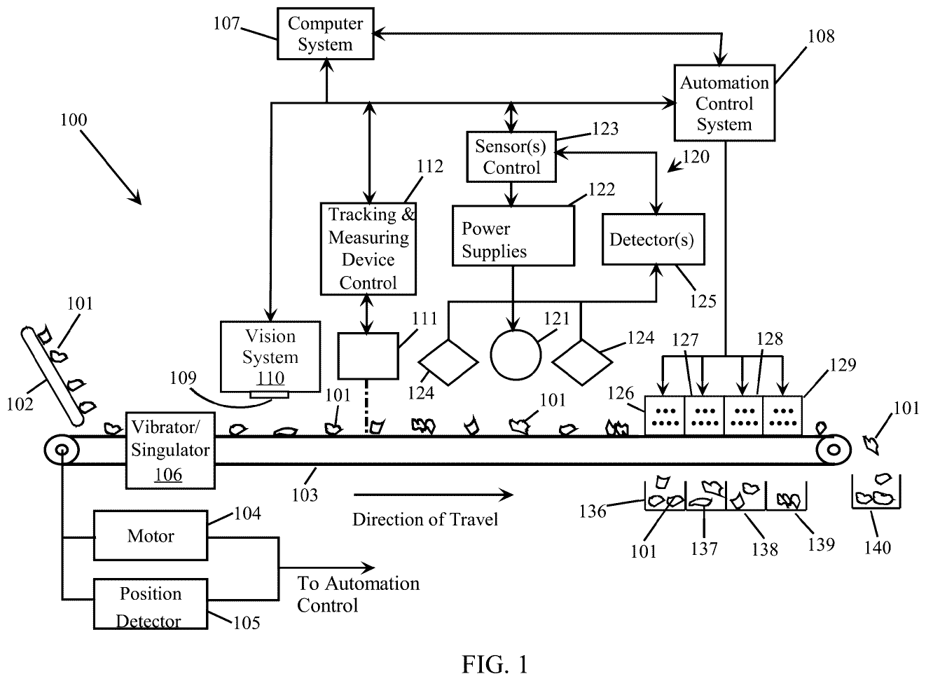

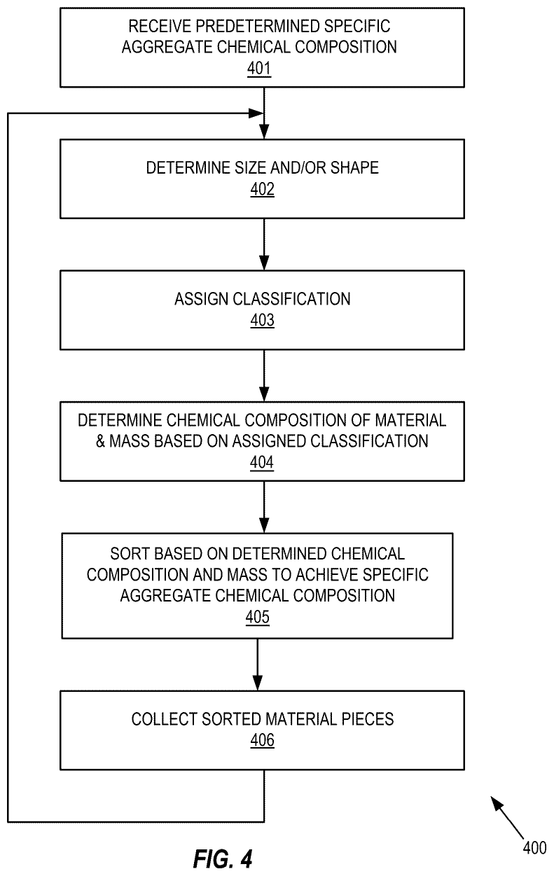

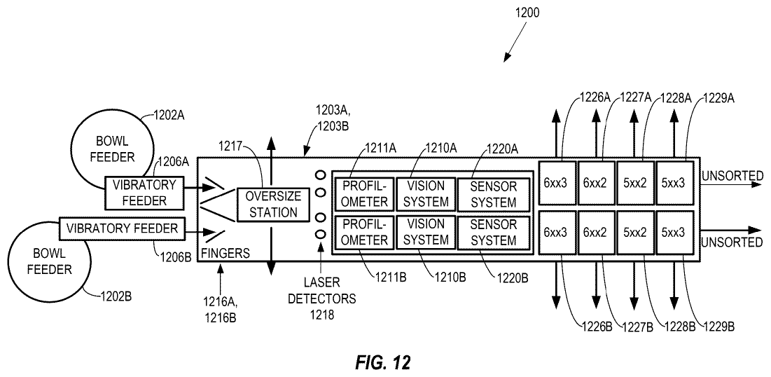

Embodiments of the present disclosure will be described herein as classifying and sorting material pieces into such separate groups or collections by physically depositing (e.g., diverting or ejecting) the material pieces into separate receptacles, or onto another conveyor system, as a function of user-defined groups or collections (e.g., specific material type classifications, fractions, or a predetermined specific aggregate chemical composition). FIGS. 1, 9, and 10 disclose systems and processes that may generally be utilized for classifying and/or sorting materials. FIG. 4 discloses a system and process for classified and sorting material pieces into one or more predetermined specific aggregate chemical compositions. FIGS. 12-15 disclose systems and processes for classifying and sorting materials from a contiguous stream of materials continuously position/deposited onto a moving conveyor system. Components and operations described with respect to FIGS. 1, 4, 9, and 10 may be implemented within the system and process of FIGS. 12-15 in accordance with various embodiments of the present disclosure.

FIG. 1 illustrates an example of a material handling system 100 configured in accordance with various embodiments of the present disclosure. Aspects of components and their operations of the material handling system 100 are applicable to similar components described herein with respect to the classifying/sorting system 1200 as disclosed with respect to FIGS. 12-15.

A conveyor system 103 may be implemented to convey one or more streams (organized (e.g., singulated), contiguous, or random) of individual material pieces 101 through the material handling system 100 so that each of the individual material pieces 101, or segments of material pieces 101, can be tracked, classified, and sorted into predetermined desired groups or collections. Such a conveyor system 103 may be implemented with one or more conveyor belts on which the material pieces 101 travel, typically at a predetermined constant speed. However, certain embodiments of the present disclosure may be implemented with other types of conveyor systems (as disclosed herein), including a system in which the material pieces free fall past selected components of the material handling system 100 (or any other type of vertical sorter). Hereinafter, wherein applicable, the conveyor system 103 may also be referred to as the conveyor belt 103. In one or more embodiments, some or all of the acts of conveying, tracking, stimulating, detecting, classifying, and sorting may be performed automatically, i.e., without human intervention. For example, in the material handling system 100, one or more sources of stimuli, one or more emissions detectors, a classification module, a sorting apparatus, and/or other system components may be configured to perform these and other operations automatically.

Furthermore, though the simplified illustration in FIG. 1 depicts a single (e.g., singulated) stream of material pieces 101 on a conveyor belt 103, embodiments of the present disclosure may be implemented in which a plurality of such streams of material pieces are passing by the various components of the material handling system 100 in parallel with each other. For example, as further described with respect to FIG. 12, the material pieces may be distributed into two or more parallel singulated streams travelling on a single conveyor belt, or a set of parallel conveyor belts. In accordance with certain embodiments of the present disclosure, incorporation or use of a singulator is not required. Instead, the conveyor system (e.g., the conveyor system 103) may simply convey a mass of material pieces, which have been deposited onto the conveyor system 103 in a random manner (or deposited in mass onto the conveyor system 103 and then caused to separate, such as by a vibrating mechanism). As such, certain embodiments of the present disclosure are capable of simultaneously tracking, classifying, and/or sorting a plurality of such conveyed material pieces.

In accordance with certain embodiments of the present disclosure, some sort of suitable feeder mechanism 102 (e.g., another conveyor system, bowl feeder, vibratory feeder, or hopper) may be utilized to position, deposit, or feed the material pieces 101 onto the conveyor belt 103, whereby the conveyor belt 103 conveys the material pieces 101 past various components within the material handling system 100. After the material pieces 101 are received by the conveyor belt 103, an optional tumbler/vibrator/singulator 106 may be utilized to separate the individual material pieces from a combined mass of material pieces. Within certain embodiments of the present disclosure, the conveyor belt 103 is operated to travel at a predetermined speed by a conveyor belt motor 104. This predetermined speed may be programmable and/or adjustable by the operator in any well-known manner. Monitoring of the predetermined speed of the conveyor belt 103 may alternatively be performed with a position detector 105. Within certain embodiments of the present disclosure, control of the conveyor belt motor 104 and/or the position detector 105 may be performed by an automation control system 108. Such an automation control system 108 may be operated under the control of a computer system 107 and/or the functions for performing the automation control may be implemented in software within the computer system 107.

Thus, as will be further described herein, through the utilization of the controls to the conveyor belt drive motor 104 and/or the automation control system 108 (and alternatively including the position detector 105), as each of the material pieces 101 travelling on the conveyor belt 103 are identified, they can be tracked by location and time (relative to the various components of the material handling system 100) so that various components of the material handling system 100 can be activated/deactivated as each material piece 101 passes within their vicinity. As a result, the automation control system 108 is able to track the location of each of the material pieces 101 while they travel along the conveyor belt 103.

Referring again to FIG. 1, certain embodiments of the present disclosure may utilize a vision, or optical recognition, system 110 and/or a material tracking and measuring device 111 and accompanying control system 112 to track each of the material pieces 101 as they travel on the conveyor belt 103. The vision system 110 may utilize one or more still or live action cameras 109 to note the position (i.e., location and timing) of each of the material pieces 101 on the moving conveyor belt 103.

The vision system 110 may be further, or alternatively, configured to perform certain types of identification (e.g., classification) of all or a portion (e.g., segment(s)) of the material pieces 101, as will be further described herein. For example, such a vision system 110 may be utilized to capture or acquire information about each of the material pieces 101. For example, the vision system 110 may be configured (e.g., with an artificial intelligence (“AI”) system) to capture or collect any type of information from the material pieces that can be utilized within the material handling system 100 to classify the material pieces 101 as a function of a set of one or more characteristics (e.g., physical and/or chemical and/or radioactive, etc.) as described herein. In accordance with certain embodiments of the present disclosure, the vision system 110 may capture visual images of each of the material pieces 101 (including one-dimensional, two-dimensional, three-dimensional, or holographic imaging), for example, by using an optical sensor as utilized in typical digital cameras and video equipment. Such visual images captured by the optical sensor are then stored in a memory device as image data (e.g., formatted as image data packets). In accordance with certain embodiments of the present disclosure, such image data may represent images captured within optical wavelengths of light (i.e., the wavelengths of light that are observable by the typical human eye).

In accordance with certain embodiments of the present disclosure, the material handling system 100 may be implemented with one or more sensor systems 120, which may be utilized solely or in combination with the vision system 110, to classify/identify material pieces 101. A sensor system 120 may be configured with any type of sensor technology, including sensor systems utilizing irradiated or reflected electromagnetic radiation (e.g., utilizing infrared (“IR”), Fourier Transform IR (“FTIR”), Forward-looking Infrared (“FLIR”), Very Near Infrared (“VNIR”), Near Infrared (“NIR”), Short Wavelength Infrared (“SWIR”), Long Wavelength Infrared (“LWIR”), Medium Wavelength Infrared (“MWIR” or “MIR”), X-Ray Transmission (“XRT”), Gamma Ray, Ultraviolet (“UV”), X-Ray Fluorescence (“XRF”), Laser Induced Breakdown Spectroscopy (“LIBS”), Raman Spectroscopy, Anti-stokes Raman Spectroscopy, Gamma Spectroscopy, Hyperspectral Spectroscopy, Acoustic Spectroscopy, NMR Spectroscopy, Microwave Spectroscopy, Terahertz Spectroscopy, and including one-dimensional, two-dimensional, three-dimensional, or holographic imaging with any of the foregoing), or by any other type of sensor technology, including but not limited to, chemical or radioactive.

It should be noted that though FIG. 1 is illustrated with a combination of a vision system 110 and one or more sensor systems 120, embodiments of the present disclosure may be implemented with any combination of sensor systems utilizing any of the sensor technologies disclosed herein, or any other sensor technologies currently available or developed in the future. Though FIG. 1 is illustrated as including one or more sensor systems 120, implementation of such sensor system(s) is optional within certain embodiments of the present disclosure. Within certain embodiments of the present disclosure, a combination of one or more vision systems and one or more sensor systems may be used to classify materials. Within certain embodiments of the present disclosure, any combination of one or more of the different sensor technologies disclosed herein may be used to classify materials without utilization of a vision system 110. Furthermore, embodiments of the present disclosure may include any combinations of one or more sensor systems and/or vision systems in which the outputs of such sensor and/or vision systems are processed in a combined or fused manner (e.g., within an AI system) in order to classify/identify materials, which may then be sorted from each other. If a sorting system (e.g., material handling system 100) is configured to operate solely with such a sensor system(s) 120, then the vision system 110 may be omitted from the material handling system 100 (or simply deactivated).

Though embodiments of the present disclosure (including the material handling system 100 and the classifying/sorting system 1200) are described as implementing separate vision and sensor systems, certain recitations in the claims to a sensor system refer to either a vision system or a sensor system.

In accordance with certain embodiments of the present disclosure, and as further described herein with respect to FIG. 4, a vision system 110 and/or sensor system(s) 120 may be configured to identify which materials are not of the kind (e.g., material pieces containing a specific contaminant or chemical element or packets of material not meeting a threshold quality (or quantity) or value as described with respect to FIGS. 12-15) to be sorted by the material handling system 100 for inclusion within a group or collection (e.g., to produce a predetermined specific aggregate chemical composition, achieve a predetermined threshold level of required purity or quality (or quantity), and/or achieve a predetermined threshold relative value), and send a signal to not sort such material pieces into a specific receptacle.

Within certain embodiments of the present disclosure, the material tracking and measuring device 111 (which may be implemented with one or more profilometers or other type of imaging device) and accompanying control system 112 may be utilized and configured to measure the sizes and/or shapes of each of the material pieces 101 as they pass within proximity of the material tracking and measuring device 111, which may be utilized to determine the approximate quantity/amount/weight/mass of each of the material pieces.

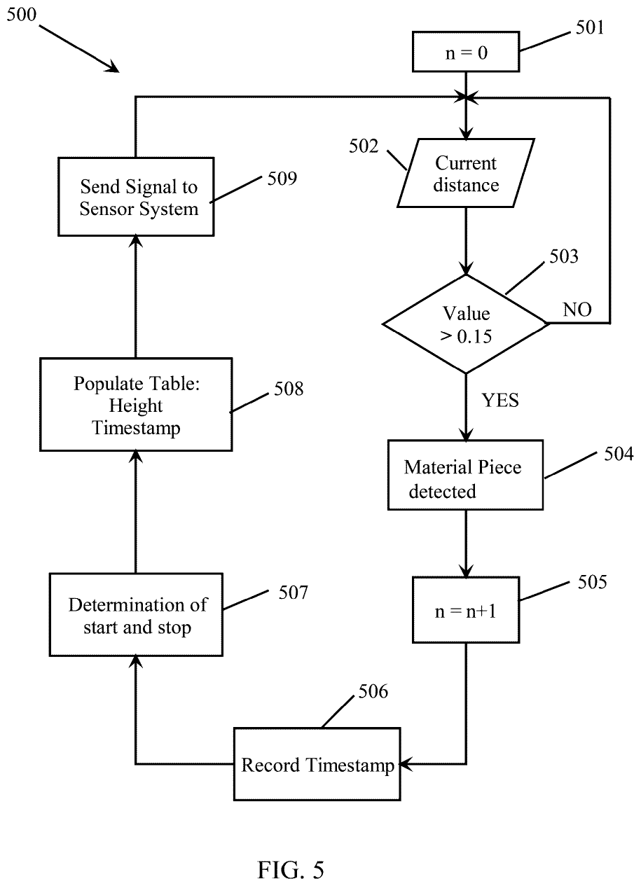

In accordance with embodiments of the present disclosure, such a material tracking and measuring device 111 may be implemented with a well-known laser light system (e.g., see the laser detectors 1218 of FIG. 12), which continuously measures a distance the laser light travels before being reflected back into a detector of the laser light system. As such, as each of the material pieces 101 passes within proximity of the device 111, it outputs a signal to the control system 112 indicating such distance measurements. Therefore, such a signal may substantially represent an intermittent series of pulses whereby the baseline of the signal is produced as a result of a measurement of the distance between the device 111 and the conveyor belt 103 during those moments when a material piece is not in the proximity of the device 111, while each pulse provides a measurement of the distance between the device 111 and successive portions of a material piece 101 passing by on the conveyor belt 103. Since the material pieces 101 may have irregular shapes, such a pulse signal may also occasionally have an irregular height. Nevertheless, each pulse signal generated by the device 111 may provide the height (or relative heights) of successive portions of each of the material pieces 101 as they pass by on the conveyor belt 103. The length of each of such pulses can also provide a measurement of a length (also referred to herein as a “span”) of each of the material pieces 101 measured along a line substantially parallel to the direction of travel of the conveyor belt 103. It is this length (span) measurement (corresponding to the time stamp of process block 506 of FIG. 5) (and alternatively the height measurements) that may be utilized within certain embodiments of the present disclosure to determine or at least approximate the quantity/amount/weight/mass of each material piece 101, which may then be utilized to assist in the sorting of the material pieces as further described herein.

A non-limiting, exemplary operation 500 of such a material tracking and measuring device 111 and control system 112 is described herein with respect to FIG. 5. Such a system and process 500 may be implemented within any of the vision/optical recognition systems and/or a material tracking and measuring device described herein, such as the material tracking and measuring device 111 and control system 112 illustrated in FIG. 1, or the profilometers 1211A, 1211B illustrated in FIG. 12. In the process block 501, the material tracking and measuring device may be initialized at n=0 whereby n represents a condition whereby a first material piece to be conveyed along the conveyor system has yet to be measured. As previously described, such a material tracking and measuring device may establish a baseline signal representing the distance between the material tracking and measuring device and the conveyor belt absent any presence of an object (i.e., a material piece) carried thereon. In the process block 502, the material tracking and measuring device produces a continuous, or substantially continuous, measurement of distance. The process block 503 represents a decision within the material tracking and measuring device whether the detected distance has changed from a predetermined threshold amount. Recall that once the material handling system 100 has been initiated, at some point in time, a material piece 101 will travel along the conveyor system in sufficient proximity to the material tracking and measuring device as to be detected by the employed mechanism by which distances are measured. In embodiments of the present disclosure, this may occur when a travelling material piece 101 passes within the line of a laser light utilized for measuring distances. Once an object, such as a material piece 101, begins to be detected by the material tracking and measuring device (e.g., a laser light), the distance measured by the material tracking and measuring device will change from its baseline value. The material tracking and measuring device may be predetermined to only detect the presence of a material piece 101 passing within its proximity if a height of any portion of the material piece 101 is greater than the predetermined threshold distance value. FIG. 5 shows an example whereby such a threshold value is 0.15 (e.g., representing 0.15 mm), though embodiments of the present disclosure should not be limited to any particular value.

The system and process 500 will continue (i.e., repeat the process blocks 502-503) to measure the current distance as long as this threshold distance value has not been reached. Once a measured height greater than the threshold value has been detected, the system and process 500 will proceed to the process block 504 to record that a material piece 101 passing within proximity of the material tracking and measuring device has been detected on the conveyor system. Thereafter, in the process block 505, the variable n may be incremented to indicate to the material handling system 100 that another material piece 101 has been detected on the conveyor system. This variable n may be utilized in assisting with tracking of each of the material pieces 101. In the process block 506, a time stamp is recorded for the detected material piece 101, which may be utilized by the material handling system 100 to track the specific location and timing of a detected material piece 101 as it travels on the conveyor system, while also representing a length of the detected material piece 101. In the optional process block 507, this recorded time stamp may then be utilized for determining when to activate (start) and deactivate (stop) the acquisition of a sensor-initiated measurement signal (e.g., an x-ray fluorescence spectrum from a material piece 101) associated with the time stamp. The start and stop times of the time stamp may correspond to the aforementioned pulse signal produced by the material tracking and measuring device. In the process block 508, this time stamp along with the recorded height of the material piece 101 may be recorded within a table utilized by the material handling system 100 to keep track of each of the material pieces 101 and their resultant classification.

Thereafter, in the optional process block 509, signals may then be sent to the sensor system indicating the time period in which to activate/deactivate the acquisition of a sensor-initiated measurement signal from the material piece 101, which may include the start and stop times corresponding to the length (span) of the material piece 101 determined by the material tracking and measuring device. Embodiments of the present disclosure are able to accomplish such a task because of the time stamp and known predetermined speed of the conveyor system received from the material tracking and measuring device indicating when a leading edge of the material piece 101 will pass by the irradiating source, and when the trailing edge of the material piece 101 will thereafter pass by the irradiating source.

The system and process 500 for distance measuring of each of the material pieces 101 travelling along the conveyor system may then be repeated for each passing material piece 101.

In accordance with embodiments of the present disclosure, when implemented with respect to the classifying/sorting system 1200, the system and process 500 may be configured to operate on each segment of a material piece whereby measurements by the material tracking and measuring device are collected on a segment-by-segment basis.

Within embodiments of the present disclosure that implement one or more sensor systems 120, the one or more sensor systems 120 may be configured to identify the chemical composition, relative chemical compositions, and/or manufacturing types of each of the material pieces 101 as they pass within proximity of the one or more sensor systems 120. The one or more sensor systems 120 may include an energy emitting source 121, which may be powered by a power supply 122, for example, in order to stimulate a response from each of the material pieces 101.

In accordance with certain embodiments of the present disclosure that implement an XRF system as a sensor system 120, the source 121 may include an in-line x-ray fluorescence (“IL-XRF”) tube, such as further described within U.S. Pat. No. 10,207,296. Such an IL-XRF tube may include a separate x-ray source each dedicated for one or more streams (e.g., singulated) of conveyed material pieces. In such a case, the one or more detectors 124 may be implemented as XRF detectors to detect fluoresced x-rays from material pieces 101 within each of the singulated streams. Nevertheless, the XRF system may be implemented with any commercially available XRF spectrometer.

Within embodiments of the present disclosure, as each material piece 101 passes within proximity to the emitting source 121, a sensor system 120 may emit an appropriate sensing signal towards the material piece 101. One or more detectors 124 may be positioned and configured to measure/sense/detect one or more characteristics from the material piece 101 in a form appropriate for the type of utilized sensor technology. The one or more detectors 124 and the associated detector electronics 125 capture these received characteristics to perform signal processing thereon and produce digitized information representing the measured characteristics (e.g., XRF spectral data), which is then analyzed in accordance with certain embodiments of the present disclosure, which may be used in order to classify each of the material pieces 101. This classification, which may be performed within the computer system 107, may then be utilized by the automation control system 108 to send instructions/signals to a sorting apparatus to activate one of the N (N>1) sorting devices 126 . . . 129 of the sorting apparatus for sorting (e.g., diverting/ejecting) selected material pieces 101 into one or more N (N>1) sorting receptacles 136 . . . 139 according to the determined classifications/evaluations as described herein. Four sorting devices 126 . . . 129 and four sorting receptacles 136 . . . 139 associated with the sorting devices are illustrated in FIG. 1 as merely a non-limiting example.

The sorting apparatus may include any well-known mechanisms for redirecting (sorting) selected material pieces 101 towards a desired location, including, but not limited to, diverting the material pieces 101 from the conveyor system into a plurality of sorting receptacles. For example, a sorting apparatus may utilize sets of one or more air nozzles, with each of the air nozzle sets assigned to one or more of the classifications. When one of the air nozzle sets (e.g., 127) receives a signal from the automation control system 108, that air nozzle set emits one or more streams of air that causes one or more selected material pieces 101 to be diverted/ejected from the conveyor system 103 into a sorting receptacle (e.g., 137) corresponding to that air nozzle set.

Other mechanisms may be used to divert/eject the material pieces, such as robotically removing the material pieces from the conveyor belt, pushing the material pieces from the conveyor belt (e.g., with paint brush type plungers), causing an opening (e.g., a trap door) in the conveyor system 103 from which a material piece may drop, or using air nozzle sets to divert the material pieces into separate receptacles as they fall from the edge of the conveyor belt. A pusher device, as that term is used herein, may refer to any form of device which may be activated to dynamically displace an object on or from a conveyor system/device, employing pneumatic, mechanical, or other means to do so, such as any appropriate type of mechanical pushing mechanism (e.g., an ACME screw drive), pneumatic pushing mechanism, or air nozzle pushing mechanism. Some embodiments may include multiple air nozzle sets located at different locations and/or with different diversion path orientations along the path of the conveyor system.

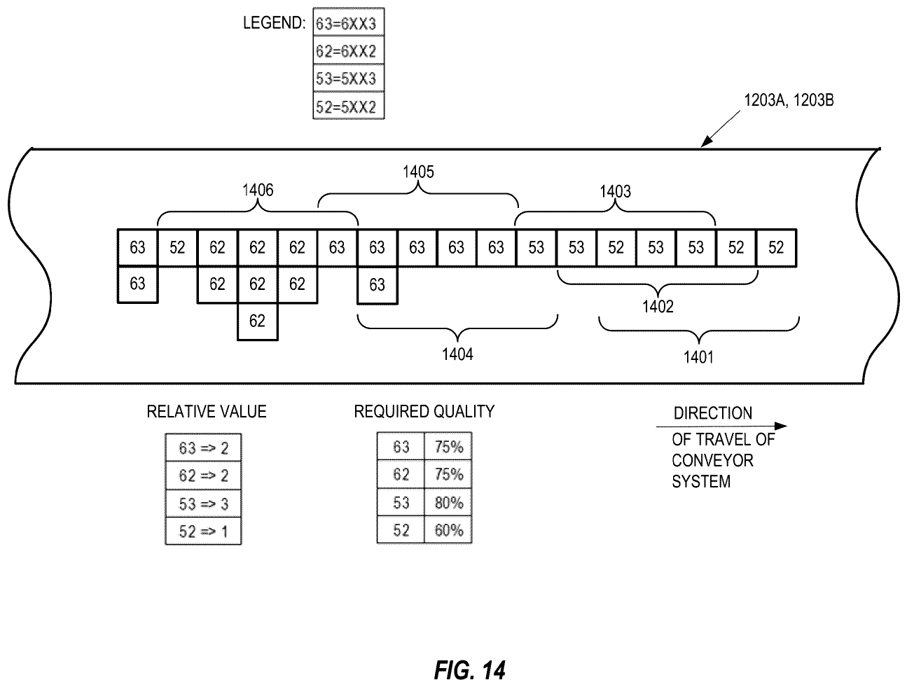

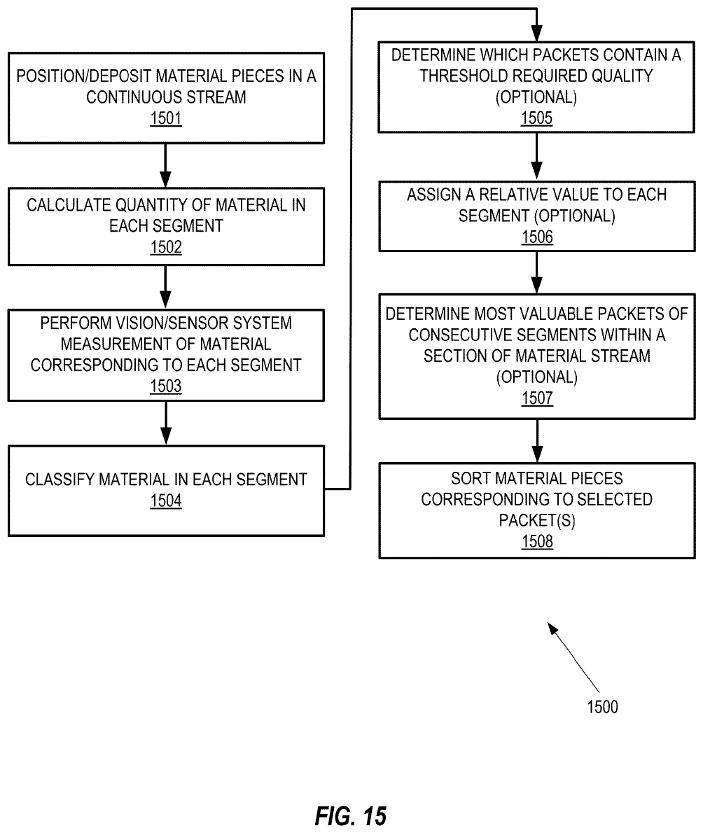

In addition to the N sorting receptacles 136 . . . 139 into which material pieces 101 are diverted/ejected, the material handling system 100 may also include a receptacle 140 that receives material pieces 101 not diverted/ejected from the conveyor system 103 into any of the aforementioned sorting receptacles 136 . . . 139. For example, a material piece 101 may not be diverted/ejected from the conveyor system 103 into one of the N sorting receptacles 136 . . . 139 when the material classification is not determined (or simply because the sorting devices failed to adequately divert/eject a material piece), when the material piece 101 contains a contaminant detected by the vision system 110 and/or the sensor system 120, or because the material piece 101 is not required to produce a particular aggregate chemical composition. Alternatively, the receptacle 140 may be used to receive one or more material pieces that belong to packets that have deliberately been evaluated to not be sorted out to any of the N sorting receptacles 136 . . . 139, such as described with respect to FIGS. 14-15.

It should be appreciated that, although the systems and methods described herein are described primarily in relation to classifying materials in solid state, the disclosure is not so limited. The systems and methods described herein may be applied to classifying materials having any of a range of physical states, including, but not limited to a liquid, molten, gaseous, or powdered solid state, another state, and any suitable combination thereof.

In accordance with embodiments of the present disclosure, regardless of the type(s) of sensed (measured) characteristics/information captured of the material pieces or segments of material pieces, the information may then be sent to a computer system (e.g., computer system 107) to be processed by an AI system in order to identify and/or classify each of the material pieces. Such an AI system may implement any well-known AI system (e.g., Artificial Narrow Intelligence (“ANI”), Artificial General Intelligence (“AGI”), Artificial Super Intelligence (“ASI”)), a machine learning system including one that implements a neural network (e.g., artificial neural network, deep neural network, multilayer perceptron, convolutional neural network, recurrent neural network, autoencoders, transformer-based model (e.g., multimodal large language model (“LLM”) (multimodal LLM), vision language model (“VLM”) etc.), a machine learning system implementing supervised learning, unsupervised learning, semi-supervised learning, weak supervised learning, reinforcement learning (e.g., represented by a Markov decision process (“MDP”) and/or implemented using Markov chains), self-learning, feature learning, sparse dictionary learning, anomaly detection, robot learning, association rule learning, fuzzy logic, deep learning algorithms, deep structured learning hierarchical learning algorithms, decision tree learning (e.g., classification and regression tree (“CART”), ensemble methods (e.g., ensemble learning, Random Forests, Bagging and Pasting, Patches and Subspaces, Boosting, Stacking, etc.), dimensionality reduction (e.g., Projection, Manifold Learning, Principal Components Analysis, etc.), and/or deep machine learning algorithms, such as those described in and publicly available at the fast.ai website (including all software, publications, and hyperlinks to available software referenced within this website), which is hereby incorporated by reference herein. Non-limiting examples of publicly available machine learning software and libraries that could be utilized within embodiments of the present disclosure include Python, OpenCV, Inception, Theano, Torch, PyTorch, Pylearn2, Numpy, Blocks, TensorFlow, MXNet, Caffe, Lasagne, Keras, Qt, Ubuntu, NVIDIA drivers, Pandas, Matplotlib, github, Chainer, Matlab Deep Learning, CNTK, MatConvNet (a MATLAB toolbox implementing convolutional neural networks for computer vision applications), DeepLearnToolbox (a Matlab toolbox for Deep Learning (from Rasmus Berg Palm)), BigDL, Cuda-Convnet (a fast C++/CUDA implementation of convolutional (or more generally, feed-forward) neural networks), Deep Belief Networks, RNNLM, RNNLIB-RNNLIB, matrbm, deeplearning4j, Eblearn.lsh, deepmat, MShadow, Matplotlib, SciPy, CXXNET, Nengo-Nengo, Eblearn, cudamat, Gnumpy, 3-way factored RBM and mcRBM, mPoT (Python code using CUDAMat and Gnumpy to train models of natural images), ConvNet, Elektronn, OpenNN, NeuralDesigner, Theano Generalized Hebbian Learning, Apache Singa, Lightnet, SimpleDNN, ResNet, Contrastive Language-Image Pre-training (“CLIP”), GPT-4 Vision, Large Language and Vision Assistant (“LLaVA”), ALIGN, BLIP, and VL-BERT.

In accordance with certain embodiments of the present disclosure, when machine learning is utilized, the machine learning may be performed in two stages. For example, first, training occurs, which may be performed offline in that the material handling system 100 is not being utilized to perform actual classifying/sorting of materials. The material handling system 100 may be utilized to train the machine learning system in that homogenous sets (also referred to herein as control samples) of material pieces (i.e., having the same types or classes of materials, or falling within the same predetermined fraction) are passed through the material handling system 100 (e.g., by a conveyor system 103); and all such material pieces may not be sorted, but may be collected in a common receptacle (e.g., receptacle 140). Alternatively, the training may be performed at another location remote from the material handling system 100, including using some other mechanism for collecting sensed (measured) information (characteristics) of control sets of material pieces. In some instances, synthetic images (e.g., produced based on real-world images and/or using a generative model, such as a generative adversarial network (“GAN”), a diffusion model (e.g., DALL-E, Midjourney, Stable Diffusion, etc.)) may be used as training data to train the machine learning system. As compared to a real-world (e.g., captured) image depicting the object, a synthetic image can depict the object in a rotated state (e.g., showing the object from a different perspective), depict a different profile of the object (e.g., a profile view of the object, a plane view of the object, a section view of the object, etc.), or depict an object under different lighting conditions. A synthetic image can depict a plurality of materials (e.g., a heterogenous mixture of materials) or a homogeneous material. During this training stage, algorithms within the machine learning system extract features from the captured and/or synthesized information (e.g., using image processing techniques well known in the art). Non-limiting examples of training algorithms include, but are not limited to, linear regression, gradient descent, feed forward, polynomial regression, learning curves, regularized learning models, logistic regression, evolutionary algorithms (e.g., genetic algorithms, differential evolution, etc.), metaheuristic optimization, swarm algorithms (e.g., particle swarm optimization), hyperparameter optimization (e.g., network topology optimization, learning rate, optimization, batch size tuning, etc.), adaptive moment estimation, root mean square propagation, and Bayesian optimization. It is during this training stage that the algorithms within the machine learning system learn the relationships between materials and their features/characteristics (e.g., as captured by the vision system and/or sensor system(s)), creating a knowledge base for later classification of materials received by the material handling system 100. Such a knowledge base may include one or more libraries, wherein each library includes parameters (e.g., neural network parameters) for utilization by the machine learning system in classifying materials. For example, one particular library may include parameters configured by the training stage to recognize and classify a particular type or class of material, or one or more materials that fall with a predetermined fraction. In accordance with certain embodiments of the present disclosure, such libraries may be inputted into the machine learning system and then the user of the material handling system 100 may be able to adjust certain ones of the parameters adjust an operation of the material handling system 100 (for example, adjusting the threshold effectiveness of how well the machine learning system recognizes a particular material).

Additionally, the inclusion of certain chemical elements in material pieces results in identifiable physical features (e.g., visually discernible characteristics) in materials. As a result, when a plurality of material pieces containing such a particular chemical composition are passed through the aforementioned training stage, the machine learning system can learn how to distinguish such material pieces from others. Consequently, a machine learning system (or any AI system) configured in accordance with certain embodiments of the present disclosure may be configured to sort between materials as a function of their respective material/chemical compositions. It can be readily appreciated that embodiments of the present disclosure may be configured to utilize image data (e.g., visual images) of a material as a proxy for representations of one or more various physical and/or chemical attributes of the material (e.g., ductility, malleability, brittleness, hardness, luster, tensile strength, reactionary with various materials, etc.).

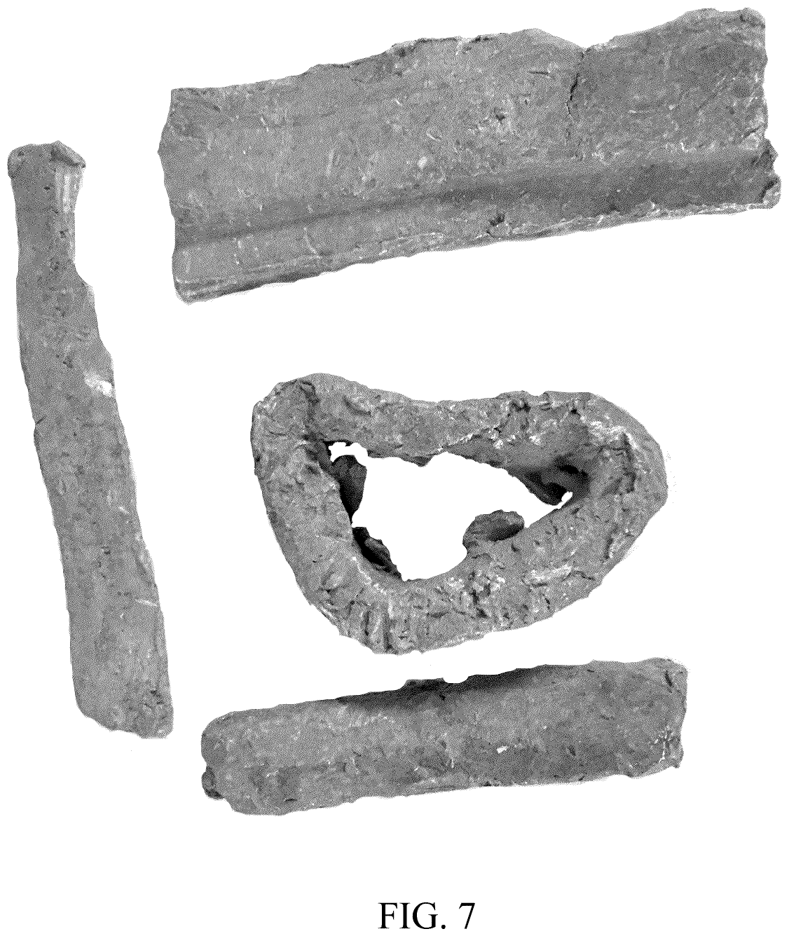

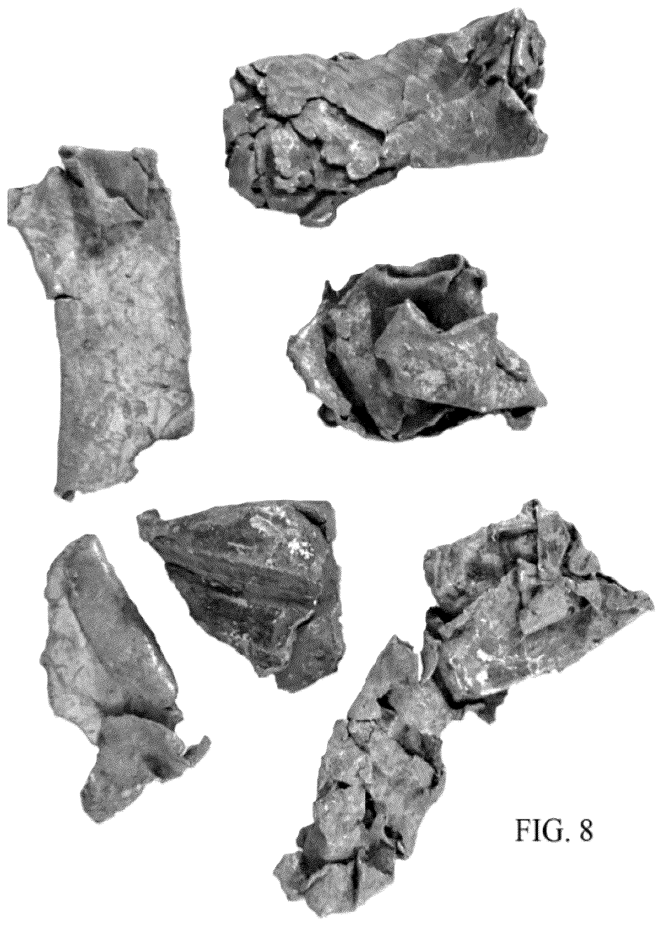

For example, FIG. 6 shows captured or acquired images of exemplary scrap pieces of cast aluminum alloys, which may be used during the aforementioned training stage. FIG. 7 shows captured or acquired images of exemplary scrap pieces of extruded aluminum alloys, which may be used during the aforementioned training stage. FIG. 8 shows captured or acquired images of exemplary scrap pieces of wrought aluminum alloys, which may be used during the aforementioned training stage. During the training stage, a plurality of material pieces of a particular (homogenous) classification (type) of material, which are the control samples, may be delivered past the vision system and/or one or more sensor system(s) (e.g., by a conveyor system) so that the algorithms within the machine learning system detect, extract, and learn what features (e.g., visually discernible characteristics) represent such a type or class of material. In other words, images of cast aluminum alloy pieces such as shown in FIG. 6 may be passed through such a training stage so that the algorithms within the machine learning system “learn” (are trained) how to detect, recognize, and classify materials composed of cast aluminum alloys; in the case of training a vision system (e.g., the vision system 110), trained to visually discern between materials. This creates a library of parameters specific to cast aluminum alloy materials. Then, the same process can be performed with respect to images of extruded aluminum alloy pieces, such as shown in FIG. 7, creating a library of parameters particular to extruded aluminum alloy materials. And, the same process can be performed with respect to images of wrought aluminum alloy pieces, such as shown in FIG. 8, creating a library of parameters particular to wrought aluminum alloy materials. As can be seen with the exemplary images of cast aluminum alloys shown in FIG. 6, such cast aluminum alloy materials have visually discernible features including, but not limited to, sharp, defined angles. As can be seen with the exemplary images of extruded aluminum alloys shown in FIG. 7, such extruded aluminum alloy materials have visually discernible features including, but not limited to, rounded corners and a “hammered” texture. As can be seen with the exemplary images of wrought aluminum alloys shown in FIG. 8, such wrought aluminum alloy materials have visually discernible features including, but not limited to, folding of the material and a smoother texture than what exists for cast and extruded.

Embodiments of the present disclosure are not limited to the exemplary materials illustrated in FIGS. 6-8. For each type of material to be classified by the vision system, any number of exemplary material pieces of that type of material may be passed by the vision system. Given a captured sensed information as input data, the algorithms within the machine learning system may use N classifiers, each of which test for one of N different material types, classes, or fractions. Note that the machine learning system may be “taught” (trained) to detect any type, class, or fraction of material, including any of the types, classes, or fractions of materials found within MSW, or any other material in which its chemical composition results in visually discernible features. Alternatively, or in addition, the machine learning system can perform zero-shot classification, i.e., classifying, during an inferencing phase, a sample from a class that was not observed during the training stage. Zero-shot classification can be implemented, for example, by embedding a plurality of classes in a continuous latent space, such that the machine learning system can predict that a sample is associated with a position within that continuous latent space.

After parameters within the algorithms have been established and the machine learning system has sufficiently learned (been trained) the differences (e.g., visually discernible differences) for the material classifications (e.g., within a user-defined level of statistical confidence), the libraries for the different material classifications are then implemented into a material classifying and/or sorting system (e.g., the material handling system 100 or the classifying/sorting system 1200) to be used during an inferencing stage for identifying and/or classifying materials, and then sorting such classified materials if sorting is to be performed.

In accordance with certain embodiments of the present disclosure, any sensed (measured) characteristics output by any of the sensor systems 120 disclosed herein may be input into a machine learning system in order to classify and/or sort materials. For example, in a machine learning system implementing supervised learning, sensor system 120 outputs that uniquely characterize a specific type or composition of material (e.g., a specific metal alloy) may be used to train the machine learning system.

In accordance with certain embodiments of the present disclosure, instead of utilizing a training stage whereby control (homogenous) samples of material pieces are passed by the vision system, training of the machine learning system may be performed utilizing a labeling/annotation technique (or any other supervised learning technique) whereby as data/information of material pieces are captured by a vision system, a user inputs a label or annotation that identifies each material piece, which is then used to create the library for use by the machine learning system when classifying materials within a heterogenous mixture of material pieces. In other words, a previously generated knowledge base of characteristics captured from one or more samples of a class of materials may be accomplished by any of the techniques disclosed herein, whereby such a knowledge base is then utilized to automatically classify materials. In some instances, a knowledge base can be expanded using weak and/or semi-supervision (e.g., implemented using generative models, low-density separation, Laplacian regularization, and/or the like).

In some instances, the machine learning system can receive, as input, image data (e.g., an RGB image having three channels, a greyscale image having one channel, etc.). Alternatively, or in addition, the machine learning system can receive, as input, signal data (e.g., waveform data, a measurement signal (e.g., associated with x-ray fluorescence), temporal data associated with a time domain, etc.), spectral data (e.g., spectral density data, data associated with a frequency domain, histogram data, etc.), point cloud data (e.g., data collected via Lidar), and/or the like. The machine learning system can generate, as output, an identified class (e.g., generated using a softmax classifier and/or the like), a probability distribution across a plurality of classes, a metric (e.g., a purity metric, a composition metric, and/or the like, generated using a regression layer and/or the like), a bounding box, an image region (e.g., a segmented subset of pixels from an image), an indication of an action (e.g., a signal to be sent to an actuator to cause sorting to be performed), etc.

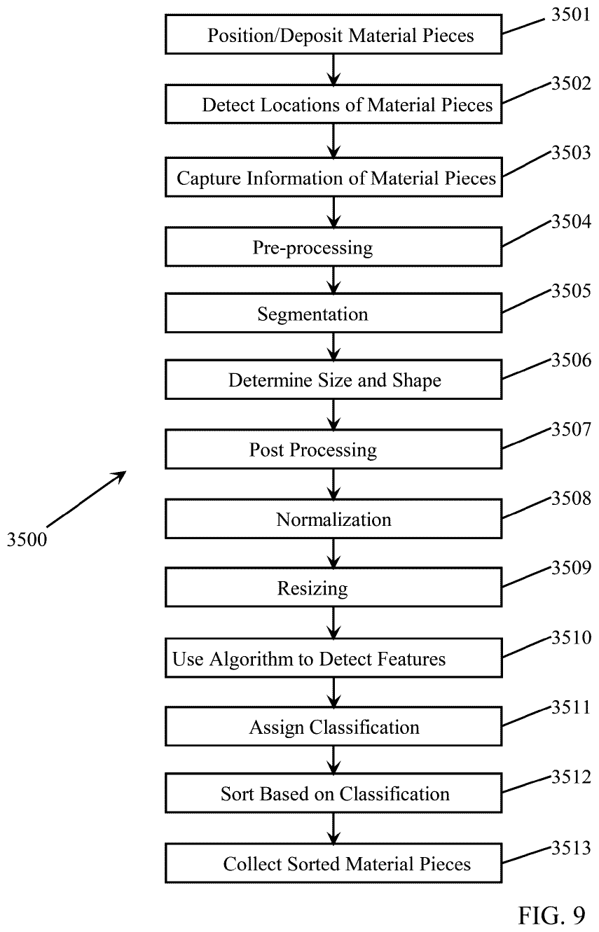

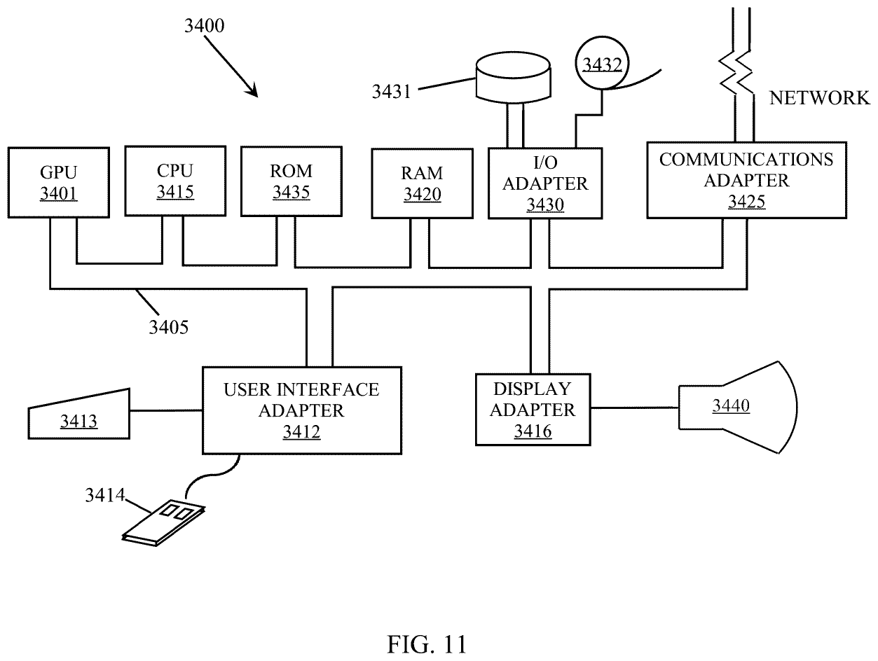

FIG. 9 illustrates a flowchart diagram depicting exemplary embodiments of a process 3500 of classifying/sorting materials utilizing a vision system 110 and/or one or more sensor systems 120 in accordance with certain embodiments of the present disclosure. The process 3500 may be performed to classify/sort a mixture of material pieces into any combination of predetermined types, classes, and/or fractions, including to produce a predetermined specific aggregate chemical composition. Though the process 3500 is described with respect to utilization within the material handling system 100, the process 3500 may be configured to operate within any of the embodiments of the present disclosure described herein, including the classifying/sorting system 1200 of FIG. 12. As will be further described, the process 3500 may be utilized within the system and process 400 of FIG. 4. Operation of the process 3500 may be performed by hardware and/or software, including within a computer system (e.g., computer system 3400 of FIG. 11) controlling the system (e.g., the computer system 107, the vision system 110, and/or the sensor system(s) 120 of FIG. 1).

In the process block 3501, the material pieces 101 may be positioned or deposited onto a conveyor system 103. In the process block 3502, the location on the conveyor system 103 of each material piece 101 is detected for tracking of each material piece 101 as it travels through the material handling system 100. This may be performed by the vision system 110 (for example, by distinguishing a material piece 101 from the underlying conveyor system material while in communication with a conveyor system position detector (e.g., the position detector 105)). Alternatively, a material tracking device 111 can be used to track the material pieces 101. Or, any system that can create a light source (including, but not limited to, visual light, UV, and IR) and has a corresponding detector can be used to track the material pieces 101. In the process block 3503, when a material piece 101 has traveled in proximity to one or more of the vision system 110 and/or the sensor system(s) 120, sensed (measured) information/characteristics of the material piece 101 is captured/acquired. In the process block 3504, a vision system (e.g., implemented within the computer system 107), such as disclosed herein, may perform pre-processing of the captured information, which may be utilized to detect (extract) information of each of the material pieces 101; in other words, the pre-processing may be utilized to identify the difference between the material piece 101 and the background (e.g., the conveyor belt 103)). Well-known image processing techniques (e.g., dilation, thresholding, and contouring) may be utilized to identify the material piece 101 as being distinct from the background. In the process block 3505, image segmentation may be performed. Additionally, a particular material piece 101 may be located on a seam of the conveyor belt 103 when its image is captured. Therefore, it may be desired in such instances to isolate the image of an individual material piece 101 from the background of the image. In an exemplary technique for the process block 3505, a first step is to apply a high contrast of the image; in this fashion, background pixels are reduced to substantially all black pixels, and at least some of the pixels pertaining to the material piece 101 are brightened to substantially all white pixels. The image pixels of the material piece 101 that are white are then dilated to cover the entire size of the material piece 101. After this step, the location of the material piece 101 is a high contrast image of all white pixels on a black background. Then, a contouring algorithm can be utilized to detect boundaries of the material piece 101. The boundary information is saved, and the boundary locations are then transferred to the original image. Segmentation is then performed on the original image on an area greater than the boundary that was earlier defined. In this fashion, the material piece 101 is identified and separated from the background.

In the optional process block 3506, the material pieces 101 may be conveyed along the conveyor system 103 within proximity of a material tracking and measuring device 111 and/or a sensor system 120 in order to determine a size and/or shape of the material pieces 101 such as described herein. Such a material tracking and measuring device 111 may be configured to measure one or more dimensions of each material piece so that the system can calculate (determine) an approximate quantity/amount/weight/mass of each material piece. In the process block 3507, post processing may be performed. Post processing may involve resizing the captured information/data to prepare it for use in an AI system. This may also include modifying certain properties (e.g., enhancing image contrast, changing the image background, or applying filters) in a manner that will yield an enhancement to the capability of the AI system to classify the material pieces 101. In the process block 3508, normalization may be performed on the data. In the process block 3509, the data may be resized. Data resizing may be desired under certain circumstances to match the data input requirements for certain AI systems, such as neural networks. For example, neural networks may require much smaller image data sizes (e.g., 225×255 pixels or 299×299 pixels) than the sizes of the images captured by typical digital cameras. Moreover, the smaller the input data size, the less processing time is needed to perform the classification. Thus, smaller data sizes can increase the throughput of the material handling system 100.

In the process blocks 3510 and 3511, each material piece 101 is identified/classified based on the sensed/measured features. For example, the process block 3510 may be configured with a neural network employing one or more AI algorithms, which compare the extracted features with those stored in a previously generated knowledge base (e.g., generated during a training stage), and assigns the classification with the highest match to each of the material pieces 101 based on such a comparison. The algorithms of the AI system may process the captured information/data in a hierarchical manner by using automatically trained filters. The filter responses are then successfully combined in the next levels of the algorithms until a probability is obtained in the final step. In the process block 3511, these probabilities may be used for each of the N classifications to classify the material pieces 101. Each of the N classifications may pertain to N different predetermined classifications. For example, each of the N classifications may be assigned to one sorting receptacle, and the material piece 101 under consideration is sorted into that receptacle that corresponds to the classification returning the highest probability larger than a predefined threshold. Within embodiments of the present disclosure, such predefined thresholds may be preset by the user. A particular material piece 101 may be sorted into an outlier receptacle (e.g., sorting receptacle 140) if none of the probabilities is larger than the predetermined threshold.

Next, in the process block 3512, a sorting device 126 . . . 129 corresponding to the classification, or classifications, of the material piece 101 is activated. Between the time at which the image of the material piece 101 was captured and the time at which the sorting device 126 . . . 129 is activated, the material piece 101 has moved from the proximity of the vision system 110 and/or sensor system(s) 120 to a location downstream on the conveyor system 103 (e.g., at the rate of conveying of a conveyor system). In embodiments of the present disclosure, the activation of the sorting device 126 . . . 129 is timed such that as the material piece 101 passes the sorting device 126 . . . 129 mapped to the classification of the material piece 101, the sorting device 126 . . . 129 is activated, and the classified material piece 101 is diverted/ejected from the conveyor system 103 into its associated sorting receptacle 136 . . . 139. Within embodiments of the present disclosure, the activation of a sorting device 126 . . . 129 may be timed by a respective position detector that detects when a material piece 101 is passing before the sorting device 126 . . . 129 and sends a signal to enable the activation of the sorting device 126 . . . 129. In the process block 3513, the sorting receptacle 136 . . . 139 corresponding to the sorting device 126 . . . 129 that was activated receives the diverted/ejected material piece 101.

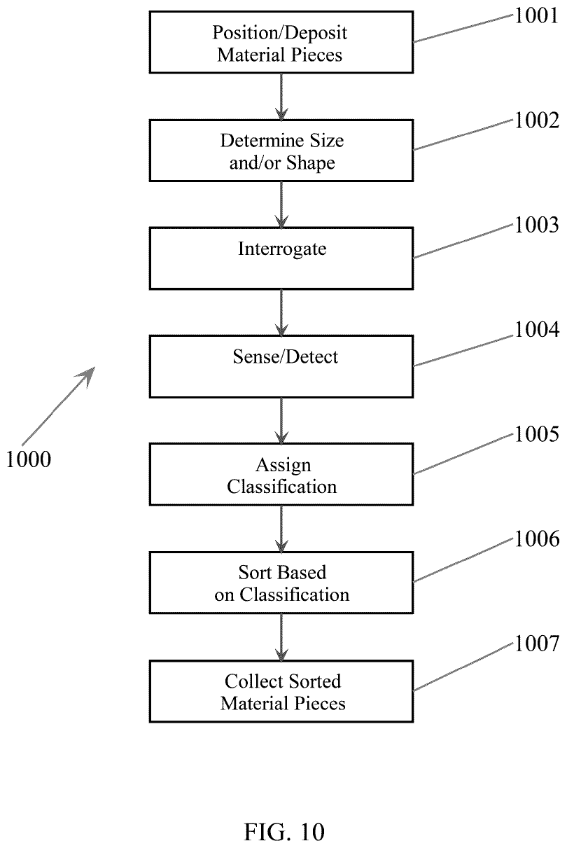

FIG. 10 illustrates a flowchart diagram depicting exemplary embodiments of a process 1000 for classifying/sorting materials in accordance with certain embodiments of the present disclosure. Though the system and process 1000 is described with respect to the material handling system 100, the process 1000 may be configured to operate within any of the embodiments of the present disclosure described herein, including the classifying/sorting system 1200 of FIG. 12. As will be further described, the process 1000 may be utilized within the system and process 400 of FIG. 4 or the system and process 1500 of FIG. 15.

In accordance with certain embodiments of the present disclosure, the process 1000 may be configured to operate in conjunction with the process 3500. For example, the process blocks 1003 and 1004 may be incorporated in the process 3500 (e.g., operating in series or in parallel with the process blocks 3503-3510) in order to combine the efforts of a vision system 110 that is implemented in conjunction with an AI system with a sensor system (e.g., a sensor system 120) that is not implemented in conjunction with an AI system in order to classify and/or sort materials, including in accordance with the system and method 400 of FIG. 4 or the system and process 1500 of FIG. 15.

Operation of the process 1000 may be performed by hardware and/or software, including within a computer system (e.g., computer system 3400 of FIG. 11) controlling various aspects of the material handling system 100 (e.g., the computer system 107 of FIG. 1) or the classifying/sorting system 1200. In the process block 1001, the material pieces 101 may be positioned/deposited onto a conveyor system 103. Next, in the optional process block 1002, the material pieces 101 may be conveyed along the conveyor system 103 within proximity of a material tracking and measuring device 111 and/or an optical imaging system and/or a profilometer in order to track each material piece and/or determine a size and/or shape of the material pieces 101. Such a material tracking and measuring device 111 or a profilometer (e.g., the profilometer 1211A, 1211B) may be configured to measure one or more dimensions of each material piece so that the system can calculate (determine) an approximate quantity/amount/weight/mass of each material piece. In the process block 1003, when a material piece 101 has traveled in proximity of the sensor system 120, the material piece 101 may be interrogated, or stimulated, with EM energy (waves) or some other type of stimulus appropriate for the particular type of sensor technology utilized by the sensor system 120. In the process block 1004, physical characteristics of the material piece 101 are measured/sensed/detected and captured/collected by the sensor system 120. In the process block 1005, for at least some of the material pieces 101, the type of material is identified/classified based (at least in part) on the captured/collected characteristics, which may be combined with the classification by an AI system in conjunction with the vision system 110 (e.g., when the system and process 100 is performed in combination with the system and process 3500).

Next, if sorting of the material pieces 101 is to be performed, in the process block 1006, a sorting device 126 . . . 129 corresponding to the classification, or classifications, of the material piece 101 is activated. Between the time at which the material piece was sensed and the time at which the sorting device 126 . . . 129 is activated, the material piece 101 has moved from the proximity of the sensor system 120 to a location downstream on the conveyor system 103, at the rate of conveying of the conveyor system. In certain embodiments of the present disclosure, the activation of the sorting device 126 . . . 129 is timed such that as the material piece 101 passes the sorting device 126 . . . 129 mapped to the classification of the material piece 101, the sorting device 126 . . . 129 is activated, and the material piece 101 is diverted/ejected from the conveyor system 103 into its associated sorting receptacle 136 . . . 139. Within certain embodiments of the present disclosure, the activation of a sorting device 126 . . . 129 may be timed by a respective position detector that detects when a material piece 101 is passing before the sorting device 126 . . . 129 and sends a signal to enable the activation of the sorting device 126 . . . 129. In the process block 1007, the sorting receptacle 136 . . . 139 corresponding to the sorting device 126 . . . 129 that was activated receives the diverted/ejected material piece 101.

FIGS. 12-15 disclose systems and methods configured to operate on a contiguous stream of materials positioned/deposited onto a moving conveyor system whereby sorting decisions are based on classifications of segments of materials, regardless of whether such segments represent whole material pieces. “Contiguous” means that consecutive adjacent material pieces within the stream are either touching (in contact) with each other or in close proximity without actually touching (i.e., there are essentially very few or no significantly large spaces (e.g., greater than a predetermined distance) between consecutive material pieces within the stream. In other words, in the case of a contiguous stream of materials, portions of the stream (also referred to herein as packets) are selected on a segment-by-segment basis for sorting decisions as opposed to making the sorting decisions on a piece-by-piece basis. Moreover, as will be readily apparent from the following description, performing classifying and sorting in such a manner may result in the sorting of material pieces into a receptacle that are not all of the same classification (e.g., in the case of aluminum alloys, 5xx2 aluminum alloy piece(s) may be sorted into a receptacle configured for primarily collecting 5xx3 aluminum alloy pieces). However, in certain commercial situations, the sorting does not need to be perfect (i.e., all sorted pieces having the same classification). For example, in the case of sorting aluminum alloy scrap pieces, a customer (e.g., a secondary smelter) may not require that all of the scrap pieces are of the same classification (e.g., 5xx3 aluminum alloys) since the customer can still make commercial use of such an “imperfect” collection of aluminum alloy scrap pieces for creating a specific aluminum alloy end product (e.g., of a commercial grade). An advantage of classifying/sorting a contiguous stream of materials is that the aforementioned disadvantages of imperfect spacing between positioned/deposited material pieces onto a conveyor system are avoided. Moreover, such a contiguous stream results in a higher throughput of material pieces onto the conveyor system (and thus a corresponding higher revenue achieved from the sorting process).

As will be further described, such a segment-by-segment classification can be optionally enhanced by inserting predetermined quality (purity) and/or relative value metrics into appropriately implemented algorithms to enable the classifying/sorting process to make “informed” or “customized” sorting decisions, which can be predetermined in order to meet user-defined sorting results (e.g., to meet a customer-required composition of the sorted materials and/or to enhance the values (e.g., commercial, financial, carbon content savings, etc.) of the sorted materials).

In accordance with embodiments of the present disclosure, lengths of segments may be predetermined to be a certain number of inches along a line in a direction of travel of the conveyor belt (e.g., one inch for each segment). Alternatively, the lengths of each segment as measured along a line of travel of the moving conveyor system may be determined as corresponding to a predetermined interval of time during which vision and/or sensor system measurements are taken of the materials within the contiguous stream, which may also be dependent upon the predetermined speed of travel of the moving conveyor system (i.e., adjustments in the lengths of the segments may be made by the user by modifying the measurement interval and/or the conveyor system speed). Nevertheless, though it is not necessary for implementing embodiments as described with respect to FIGS. 12-15, in accordance with embodiments of the present disclosure, the segment lengths may be configured so that at least one material piece within the stream is divided into at least two successive segments (e.g., less than an entire span of at least one of the material pieces measured along the line of travel of the the conveyor system).

As previously noted, sorting decisions may be performed on a plurality of M (M>1) successive segments, i.e., selected portions of the contiguous stream referred to herein as “packets.” The number of successive segments within a packet may be predetermined by the user. For example, the user may set the number of segments in a packet based on a desired (predetermined) quality to be achieved by the classification/sorting algorithm. And then, instructions can be sent to the sorting devices to achieve such a predetermined quality metric by sorting the desired packet lengths. For instance, in a non-limiting example, M could be predetermined to be equal to 5 inches where the length of each segment is predetermined to be equal to 1 inch. Or, the classifying/sorting system may be designed whereby each sorting device is configured to eject a predetermined amount of material (e.g., length of materials) from the conveyor system, which defines the number of contiguous segments that can be ejected with each sorting action and thus defines the length of each packet. For example, a sorting device (e.g., implemented with a set of one or more air nozzles) may be configured to eject (e.g., blow off) a maximum (or minimum in alternative embodiments) of M segments of material in response to a single received sorting instruction.

In accordance with embodiments of the present disclosure, there is a certain length (section) of material that has been positioned/deposited onto the conveyor system (e.g., the conveyor belts 1203A, 1203B) between the time that it is classified (see the process block 1504 of FIG. 15) and when it is sorted by the sorting devices (see the process block 1508). In accordance with embodiments of the present disclosure, a section may be predetermined to be any length (e.g., any desired measured length or any number of successive segments). For example, such a length may amount to approximately N (N>1) number of contiguous segments (for example, referring to FIG. 12, the classifying/sorting system 1200 may be configured so that there is a certain distance (e.g., three feet) along the conveyor system between the sensor systems 1220A, 1220B and the sorting devices 1226A . . . 1226B whereby this certain distance equals to approximately N number of contiguous segments (depending upon the predetermined segment lengths)). In accordance with embodiments of the present disclosure, N>M>1.

Referring to FIG. 12, there is illustrated a simplified schematic diagram of a classifying/sorting system 1200 configured in accordance with embodiments of the present disclosure. Many of the elements and corresponding operations of the classifying/sorting system 1200 may be similarly configured as their corresponding elements and operations described with respect to the material handling system 100. Therefore, for the sake of clarity, not all such aspects are repeated while describing FIGS. 12-15. However, one skilled in the art would readily be able to appropriately apply or implement the concepts described with respect to the material handling system 100 in the classifying/sorting system 1200, including, but not limited to, the operation(s) of component(s) of the material handling system 100 on segments of material pieces.

FIG. 12 illustrates a non-limiting exemplary implementation of two parallel lines of material streams to be classified/sorted, though any number of such lines may be implemented. Each lane may be fed material pieces by some sort of feeder mechanism, such as the first and second bowl feeders 1202A, 1202B (which may receive material pieces from some sort of appropriate feeder mechanism (not shown for the sake of clarity)). Each of these bowl feeders may then be configured to position/deposit material pieces onto the conveyor belts 1203A, 1203B by respective vibratory feeders 1206A, 1206B. However, implementation of such bowl feeders and/or vibratory feeders may be optional.

In accordance with embodiments of the present disclosure, the classifying/sorting system 1200 is configured to position/deposit material pieces onto the conveyor belts 1203A, 1203B as parallel contiguous streams of material pieces. One or more singulating devices, such as fingers 1216A, 1216B may be implemented for positioning the contiguous streams of material pieces into substantially a single file each. The conveyor belts 1203A, 1203B may each be configured to operate at respective predetermined speeds to move the parallel streams of material pieces past the various elements of the classifying/sorting system 1200. Though the classifying/sorting system 1200 is described with respect to parallel conveyor belts 1203A, 1203B, a single integrated conveyor system may be implemented for conveying both streams.

An optional oversize station 1217 may be implemented to detect material pieces that are larger than a predetermined size (e.g., greater than a predetermined maximum height), and to eject such oversized material pieces off of the conveyor belts 1203A, 1203B.

Each lane may be implemented with some sort of device, or devices, for determining the size and/or shape and corresponding approximate quantity/amount/weight/mass of each of the material pieces and/or to detect relative positioning of the material pieces on the conveyor belts 1203A, 1203B (e.g., for tracking locations of the material pieces for: activation of the downstream components (e.g., the vision systems 1210A, 1210B, the sensor systems 1220A, 1220B, and each of the sorting devices 1226A . . . 1229B); and/or for determining the beginning and end of each section). For example, profilometers 1211A, 1211B (or devices similar the material tracking system 111) may be implemented for such devices. Additionally, laser detectors 1218 may be optionally utilized for such devices. The laser detectors 1218 and profilometers 1211A, 1211B may be implemented either singularly or in combination with each other for such tasks.

Vision systems 1210A, 1210B may be implemented for capturing images of each of the material pieces and/or for tracking and/or classification purposes, in a similar manner as previously described with respect to the vision system 110 of the material handling system 100.

Sensor systems 1220A, 1220B may be implemented in a manner as similarly described with respect to the sensor system 120 of the material handling system 100 for classification purposes. Any type of sensor system technology (e.g., XRF, XRT, LIBS, etc.) as described herein may be utilized.

One or more sorting devices 1226A . . . 1229A and 1226B . . . 1229B are implemented for sorting out, or ejecting, material pieces or packets (as further described herein) from the conveyor belts 1203A, 1203B in accordance with the system and method 1500 described with respect to FIGS. 14-15. For example, in the case of sorting aluminum alloys, the sorting devices 1226A, 1226B may be configured for receiving instructions to sort out material pieces or packets classified as 6xx3 aluminum alloy pieces; the sorting devices 1227A, 1227B may be configured for receiving instructions to sort out material pieces or packets classified as 6xx2 aluminum alloy pieces; the sorting devices 1228A, 1228B may be configured for receiving instructions to sort out material pieces or packets classified as 5xx2 (e.g., 5052) aluminum alloy pieces; and the sorting devices 1229A, 1229B may be configured for receiving instructions to sort out material pieces or packets classified as 5xx3 aluminum alloy pieces. Sorted materials may be received in receptacles, such as described with respect to FIG. 1, or onto another conveyor system (e.g., passed to another downstream classifying/sorting system). Embodiments of the present disclosure are not limited to the sorting classifications shown in FIG. 12; the sorting devices 1226A . . . 1229B may be mapped to any material classifications described herein, or any material classifications desired by the user. Any unsorted material pieces or packets may be passed from the end of the conveyor belts 1203A, 1203B and handled accordingly (e.g., returned to be classified/sorted again by the classifying/sorting system 1200 or the material handling system 100, or passed to another downstream classifying/sorting system).

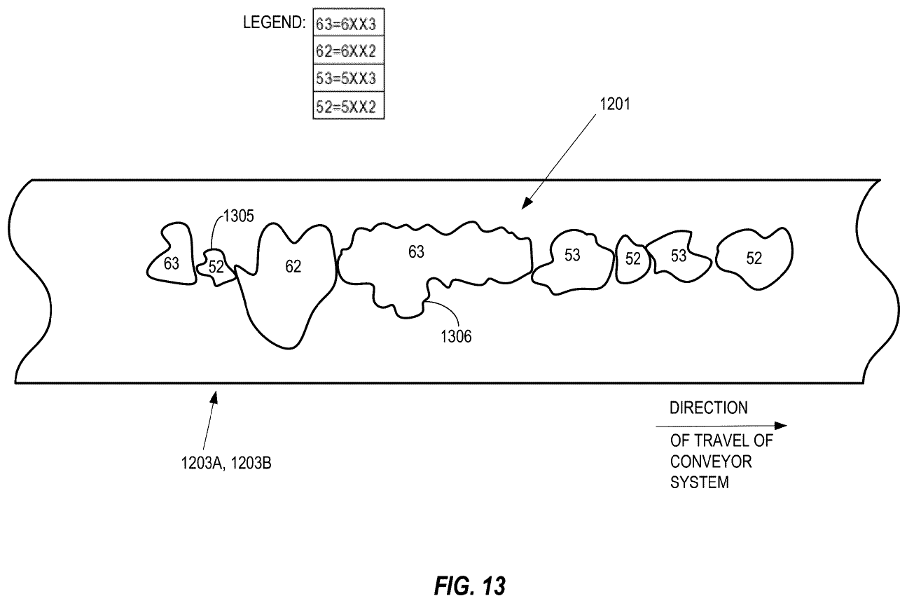

FIG. 13 illustrates a non-limiting example of how a contiguous stream of exemplary material pieces 1201 can be positioned/deposited onto a moving conveyor belt 1203A, 1203B for sorting. As can be readily appreciated, such a contiguous stream of material pieces may include material pieces of all different sizes and shapes and of different material classifications. However, these are merely non-limiting examples of how such a contiguous stream of material pieces may be positioned/deposited onto a conveyor system.

In FIG. 14, the contiguous stream of material pieces is represented by a series of blocks, where each block conceptually represents a segment of the contiguous stream of material pieces. Only one contiguous stream is represented in FIGS. 13-14 for purposes of describing embodiments of the present disclosure with respect to FIGS. 13-15.

The segments in FIG. 14 have been depicted to correspond to the contiguous stream of material pieces illustrated in FIG. 13. For example, viewing the contiguous stream in FIG. 14 from right to left, the first two blocks labeled with “52” represent that the corresponding material piece labeled as “52” in FIG. 13 is divided into two segments; the next two blocks labeled with “53” represent that the corresponding material piece labeled as “53” in FIG. 13 is also divided into two segments; the next block labeled with “52” represents that the corresponding material piece labeled as “52” in FIG. 13 is divided into one segment; the next two blocks labeled with “53” represent that the corresponding material piece labeled as “53” in FIG. 13 is divided into two segments; the next five blocks labeled with “63” represent that the corresponding material piece 1306 labeled as “63” in FIG. 13 is divided into five segments; the next three blocks labeled with “62” represent that the corresponding material piece labeled as “62” in FIG. 13 is divided into three segments; the next block labeled with “52” represents that the corresponding material piece 1305 labeled as “52” in FIG. 13 is divided into one segment; and the last block labeled with “63” represents that the corresponding material piece labeled as “63” in FIG. 13 is divided into one segment. Note that the depiction of the segments in FIG. 14 is merely a conceptual representation of how the system and process 1500 functions in order to describe embodiments of the present disclosure.

FIGS. 14 and 15 will now describe non-limiting examples of how embodiments of the present disclosure can classify, evaluate, and sort a contiguous stream of material pieces. Referring to FIG. 15, the system and process 1500 may begin in the process block 1501 with a positioning/depositing of material pieces onto a conveyor belt 1203A, 1203B in a contiguous stream (e.g., a single file (for example, singulated) stream of contiguous material pieces). Of course, mechanisms (e.g., the bowl feeders 1202A, 1202B, vibratory feeders 1206A, 1206B, fingers 1216A, 1216B) for positioning or depositing material pieces of differing shapes and sizes onto a conveyor system may not operate perfectly, and may be subject to all sorts of factors; therefore, there may be instances within the contiguous stream where there is some spacing between at least some of the adjacent material pieces. Nevertheless, embodiments of the present disclosure are configured to position/deposit the material pieces onto a conveyor system (e.g., a conveyor belt 1203A, 1203B) in a contiguous stream subject to exceptions caused by such variances in the positioning/depositing mechanisms. An overall intent of embodiments of the present disclosure is to position/deposit material pieces in a contiguous stream substantially in a manner sufficient to implement the dividing of each of the material pieces into one or more segments that are then processed as described with respect to FIGS. 14-15.

Alternatively, embodiments of the present disclosure may be configured to position/deposit the material pieces onto the conveyor system in a contiguous stream where there is a predetermined maximum amount of spacing between successive material pieces (subject to exceptions caused by variances in the depositing mechanisms) where such a predetermined maximum amount of spacing (e.g., less than one inch) still enables embodiments of the present disclosure to operate as described with respect to FIGS. 14-15.

In the process block 1502, an approximate relative quantity or amount (e.g., weight or mass) of material corresponding to each segment is determined/calculated. This may be accomplished in any appropriate manner. For example, the width (measured along a dimension perpendicular to the line of travel of a moving conveyor belt 1203A, 1203B) of the material corresponding to each predetermined segment may be determined (e.g., from the laser detectors 1218, the profilometers 1211A, 1211B, or the vision system 1210A, 1210B, or a combination of the foregoing). In other words, the width of the material pieces in the material stream is determined (measured) at intervals corresponding to the lengths of the predetermined segments. For example, if the length of a segment is predetermined to be 1 inch, then the width of the material on a conveyor belt 1203A, 1203B is determined every 1 inch. This width is then utilized to determine a relative quantity or amount of material corresponding to each segment. For example, in accordance with embodiments of the present disclosure, this width may be utilized to determine an approximate surface area of the material corresponding to each segment, and then this determined surface area may be utilized to determine (calculate) the approximate quantity of material corresponding to each segment. For example, with foreknowledge of the basic compositions of the materials fed into the material stream, an approximate weight or mass may be inferred from the width, which can be utilized to determine the relative quantity. Exemplary approximate determined quantities/amounts/weights/masses are conceptually represented in FIG. 14 by the number of depicted blocks corresponding to each segment. For example, two depicted “63” blocks aligned along a width of the conveyor belt 1203A, 1203B represents approximately twice a relative quantity of 6xx3 material corresponding to that particular segment relative to a single depicted “63” block, and so on. As will be further described with respect to the process block 1505, such relative quantities can be utilized for determining required qualities in packets.

In the process block 1503, one or more sensor system measurements (e.g., a vision system, XRF, LIBS, etc. measurement) are performed on the material corresponding to each segment as each segment of material passes by the vision system 1210A, 1210B and/or the sensor system 1220A, 1220B. Though embodiments of the present disclosure (including with respect to the material handling system 100 and the classifying/sorting system 1200) are described as implementing separate vision and sensor systems, certain recitations in the claims to a sensor system refer to either a vision system or a sensor system. Therefore, references to a sensor system measurement in FIG. 15 may refer to a measurement by a vision system 1210A, 1210B and/or a sensor system 1220A, 1220B.

In the process block 1504, the sensor system measurement(s) performed in the process block 1503 is used to classify the material corresponding to each segment (for example, by determining (e.g., by a sensor system 1220A, 1220B) or inferring (e.g., by a vision system 1210A, 1210B) the chemical composition of the material in each segment). Note that whole material pieces are not necessarily classified, but instead, each segment of the material stream is classified, whether it contains a whole material piece (e.g., see the material piece 1305 in FIG. 13, which is represented by a single segment) or a portion of a material piece (e.g., see the material piece 1306 in FIG. 13, which is divided into five segments).

In accordance with certain embodiments of the present disclosure, different classifications of materials can be assigned different purity levels (qualities). Accordingly, the system and process 1500 may optionally include a process block 1505 that determines which packet(s) (for example, within a section) contain a threshold required quality for a specific material classification. For example, the user may predetermine that the required (threshold) quality of materials to be sorted into a specified receptacle be at least a minimum percentage of that particular material classification (e.g., for a 6xx3 aluminum alloy, 75% of all pieces sorted into a specified receptacle should be classified as 6xx3, or as also further described with respect to FIG. 4, a predetermined specific aggregate composition of the material pieces sorted into a certain receptacle is set to have a threshold minimum required quality of 75%). The process block 1505 determines the relative qualities of classified materials within each packet utilizing the relative quantities determined in the process block 1502 for each segment within a packet.

FIG. 14 illustrates a non-limiting exemplary Required Quality table of assigned (predetermined) qualities for exemplary aluminum alloys, which may be inputted into the classifying/sorting system 1200 by the user (and thus possibly stored in a lookup table for utilization by the process block 1505). Thus, the classifying/sorting system 1200 may be configured to: only permit material pieces corresponding to packets containing at least a 75% quality of 6xx3 aluminum alloys to be sorted by the sorting device 1226A, 1226B; only permit material pieces corresponding to packets containing at least a 75% quality of 6xx2 aluminum alloys to be sorted by the sorting device 1227A, 1227B; only permit material pieces corresponding to packets containing at least a 80% quality of 5xx3 aluminum alloys to be sorted by the sorting device 1228A, 1228B; and only permit material pieces corresponding to packets containing at least a 60% quality of 5xx2 aluminum alloys to be sorted by the sorting device 1229A, 1229B.

In accordance with certain embodiments of the present disclosure, the system and process 1500 may be configured to operate on any appropriate combination of packets within a section to determine whether the materials in such packets meet the required threshold quality for sorting from the contiguous stream. For example, the system and process 1500 may be configured to evaluate each successive packet within a section and sort out only those material pieces corresponding to packets that meet the required quality threshold. This overall process may be repeated for the next section of segments positioned/deposited onto the conveyor system, and so on.

Additionally, the user may optionally predetermine that certain material classifications are more valuable (e.g., financially, i.e., their current commercial selling price is higher) relative to other material classifications within the material stream (e.g., in the case of aluminum alloys, 6xx3 aluminum alloys may be predetermined by the user to be more valuable than 5xx2 aluminum alloys). Thus, in accordance with certain embodiments of the present disclosure, different classifications of materials can be assigned different relative values. Accordingly, the system and process 1500 may optionally include a process block 1506 whereby a relative value (e.g., financial) or weighting is assigned to each segment based on its classification. FIG. 14 illustrates a non-limiting exemplary Relative Value table of assigned (e.g., predetermined) relative values (e.g., financial) or weightings for exemplary aluminum alloys, which may be inputted into the classifying/sorting system 1200 by the user (and thus possibly stored in a lookup table for utilization by the process block 1506).

In the optional process block 1507, the most valuable packets of contiguous segments are determined within a section of the material stream. For the sake of the non-limiting example described with respect to FIGS. 14-15, the “section” is determined to be composed of the segments depicted in FIG. 14. However, the system and method 1500 may be configured to operate on every possible packet as it passes by the elements of the classifying/sorting system 1200. In this non-limiting example, the operations of the process blocks 1505-1507 are combined to determine which packets to select for sorting. However, the system and process 1500 may be configured to only consider the relative values of segments for determining which packet(s) to select for sorting.

In FIG. 14, six of the packets are identified for describing the process block 1507 in more detail. Only the packets 1401-1406 are described in detail for the sake of simplicity. The packet 1401 is composed of three “52” segments (i.e., segments that have been classified by the process block 1506 as a 5xx2 aluminum alloy) and two “53” segments (i.e., segments that have been classified by the process block 1506 as a 5xx3 aluminum alloy). In this non-limiting example, the “52” segments have been predetermined to have a relative value (e.g., financial weighting) equal to 1, while the “53” segments have been predetermined to have a relative value equal to 3. The process block 1507 will then calculate that there are three blocks corresponding to three “52” segments, which make up 60% of the packet 1401, while there are two blocks corresponding to the two “53” segments, which make up 40% of the packet 1401. Recall from the process block 1502 that the number of blocks corresponding to a segment represents a relative quantity of material associated with that segment. According to the exemplary Required Quality table in FIG. 14, the “60%” associated with the “52” segments meets the minimum required quality for that aluminum alloy (i.e., 5xx2); the “40%” associated with the “53” segments does not meet the minimum required quality for that aluminum alloy (i.e., 5xx3). As a result of classified segments meeting the minimum required quality for at least one of the alloys (5xx2) in the packet 1401, the process block 1507 makes a predetermination (evaluation) that the segments associated with the packet 1401 may be selected for sorting out into a receptacle if it is determined to be one of the most “valuable” packets within that section of the contiguous stream of material pieces (e.g., sorted out by the sorting device 1228A, 1228B). Note that the evaluation given the packet 1401 by the process block 1507 (utilizing the Relative Value table) is with a value of 3, since there are three blocks corresponding to the “52” segments each having a relative value equal to 1.

The packet 1402 is composed of two “52” segments and three “53” segments. The process block 1507 will then calculate that there are two blocks corresponding to two “52” segments, which make up 40% of the packet 1402, while that there are three blocks corresponding to the three “53” segments, which make up 60% of the packet 1402. According to the exemplary Required Quality table in FIG. 14, the “40%” associated with the “52” segments does not meet the minimum required quality for that aluminum alloy (i.e., 5xx2), nor does the “60%” associated with the “53” segments meet the minimum required quality for that aluminum alloy (i.e., 5xx3). As a result of classified segments not meeting the minimum required quality for at least one of the alloys in the packet, the process block 1508 makes a predetermination that the segments associated with the packet 1402 are not to be selected for sorting out into a receptacle. Note that an evaluation given the packet 1402 by the process block 1507 (utilizing the Relative Value table) may or may not be performed.

The packet 1403 is composed of one “52” segment and four “53” segments. The process block 1507 will then calculate that that there is one block corresponding to the one “52” segment, which makes up 20% of the packet 1403, while that there are four blocks corresponding to the four “53” segments, which make up 80% of the packet 1403. According to the exemplary Required Quality table in FIG. 14, the “80%” associated with the “53” segments meets the minimum required quality for that aluminum alloy (i.e., 5xx3); the “20%” associated with the “52” segments does not meet the minimum required quality for that aluminum alloy (i.e., 5xx2). As a result of classified segments meeting the minimum required quality for at least one of the alloys (5xx3) in the packet 1403, the process block 1507 makes a predetermination (evaluation) that the segments associated with the packet 1403 may be selected for sorting out into a receptacle if it is determined to be one of the most “valuable” packets within that section of the contiguous stream of material pieces (e.g., sorted out by the sorting device 1229A, 1229B). Note that the evaluation given the packet 1403 by the process block 1507 (utilizing the Relative Value table) is with a value of 12, since there are four blocks associated with the “52” segments each having a relative value equal to 3.

The packet 1404 is composed of four “63” segments (i.e., segments that have been classified by the process block 1506 as a 6xx3 aluminum alloy) and one “53” segment. In this non-limiting example, the “63” segments have been predetermined to have a relative value equal to 2, while the “53” segments have been predetermined to have a relative value equal to 3. The process block 1507 will then calculate that there are five blocks corresponding to the four “63” segments, which make up 83% of the packet 1404, while there is one block corresponding to the one “53” segment, which makes up 17% of the packet 1404. According to the exemplary Required Quality table in FIG. 14, the “83%” associated with the “63” segments meets the minimum required quality for that aluminum alloy (i.e., 6xx3); the “17%” associated with the “53” segments does not meet the minimum required quality for that aluminum alloy (i.e., 5xx3). As a result of classified segments meeting the minimum required quality for at least one of the alloys (6xx3) in the packet 1404, the process block 1507 makes a predetermination (evaluation) that the segments associated with the packet 1404 may be selected for sorting out into a receptacle if it is determined to be one of the most “valuable” packets within that section of the contiguous stream of material pieces (e.g., sorted out by the sorting device 1226A, 1226B). Note that the evaluation given this packet 1404 by the process block 1507 (utilizing the Relative Value table) is with a value of 10, since there are five blocks associated with the “63” segments each having a relative value equal to 2.

The packet 1405 is composed of five “63” segments (i.e., segments that have been classified by the process block 1506 as a 6xx3 aluminum alloy). In this non-limiting example, the “63” segments have been predetermined to have a relative value equal to 2. The process block 1507 will then calculate that there are six blocks corresponding to the five “63” segments, which make up 100% of the packet 1405. According to the exemplary Required Quality table in FIG. 14, the “100%” associated with the “63” segments meets the minimum required quality for that aluminum alloy (i.e., 6xx3). As a result of classified segments meeting the minimum required quality for at least one of the alloys (6xx3) in the packet 1405, the process block 1507 makes a predetermination (evaluation) that the segments associated with the packet 1405 may be selected for sorting out into a receptacle if it is determined to be one of the most “valuable” packets within that section of the contiguous stream of material pieces (e.g., sorted out by the sorting device 1227A, 1227B). Note that the evaluation given this packet 1405 by the process block 1507 (utilizing the Relative Value table) is with a value of 12, since there are six blocks associated with the five “63” segments each having a relative value equal to 2.

The packet 1406 is composed of three “62” segments (i.e., segments that have been classified by the process block 1506 as a 6xx2 aluminum alloy), one “63” segment, and one “52” segment. In this non-limiting example, the “62” segments have been predetermined to have a relative value equal to 2, the “63” segments have been predetermined to have a relative value equal to 2, while the “52” segments have been predetermined to have a relative value equal to 1. The process block 1507 will then calculate that there are seven blocks corresponding to the three “62” segments, which make up 78% of the packet 1406, that there is one block corresponding to the one “63” segment, which makes up 11% of the packet 1406, and that there is one block corresponding to the one “52” segment, which makes up 11% of the packet 1406. According to the exemplary Required Quality table in FIG. 14, the “78%” associated with the “62” segments meets the minimum required quality for that aluminum alloy (i.e., 6xx2); the “11%” associated with the “63” segment does not meet the minimum required quality for that aluminum alloy (i.e., 6xx3); and the “11%” associated with the “52” segment does not meet the minimum required quality for that aluminum alloy (i.e., 5xx2). As a result of classified segments meeting the minimum required quality for at least one of the alloys (6xx2) in the packet 1406, the process block 1507 makes a predetermination (evaluation) that the segments associated with the packet 1406 may be selected for sorting out into a receptacle if it is determined to be one of the most “valuable” packets within that section of the contiguous stream of material pieces (e.g., sorted out by the sorting device 1227A, 1227B). Note that the evaluation given this packet 1406 by the process block 1507 (utilizing the Relative Value table) is with a value of 14, since there are seven blocks associated with the three “62” segments each having a relative value equal to 2.

Based on the foregoing, within that section of the contiguous stream of materials, the process block 1507 has made predeterminations (evaluations) that each of the packets 1401, 1403, 1404, 1405, and 1406 have a sufficient quantity of material in classified segments that meets the required minimum quality for their classified alloys as designated in the Required Quality table in FIG. 14. The process block 1507 is configured to determine which of these packets have the most “valuable” evaluations. Since the packet 1403 has a value of 12 and the packet 1406 has a value of 14, these are determined to be the most “valuable” packets within the section that can be separately selected for sorting of material pieces from the section. Sorting of either of the packets 1401 or 1404 would interfere with the sorting of the packet 1403, since they both have segments in common with the packet 1403. Consequently, the process block 1507 may then determine that material pieces corresponding to the segments associated with the packets 1403 and 1406 will be sorted out from this section.

In accordance with alternative embodiments of the present disclosure, the process block 1507 may be configured to select which packets to sort based on other predetermined algorithms. For example, the process block 1507 may be configured to select the packets 1403 and 1405 within the section since these packets precede the packet 1406 and would therefore reach the sorting devices before the packet 1406. Or the process block 1507 may be configured to select the packets 1404 and 1406, since these packets contain the highest amount of material of the most “valuable” packets within the section. Or the process block 1507 may be configured to select the packets that achieve the highest required qualities (e.g., based on the Required Quality table of FIG. 14, packets containing a threshold quality of “53” segments could be selected before selections of other packets. Or the process block may be configured to select packets that achieve the sortation of the most amount of material within each evaluated section.

In the process block 1508, the classifying/sorting system 1200 then attempts to sort out from the conveyor system (e.g., the conveyor belts 1203A, 1203B) as a group the material pieces corresponding to the segments within the packets determined to be of most value by the process block 1507 according to their classification and valuation analysis, i.e., for the case of the foregoing example, materials corresponding to the packet 1403 sorted out by the sorting device 1229A, 1229B, and materials corresponding to the packet 1406 sorted out by the sorting device 1227A, 1227B. As such, the system and process 1500 determines which packets have the highest “value” that meets the minimum required quality for each material to be sorted.

In accordance with embodiments of the present disclosure, the system and process 1500 can be configured to operate on each section of the material stream and continuously reevaluate (e.g., every several milliseconds) as new material pieces enter (see the process block 1501) and others exit the conveyor system (see the process block 1508). The system and process 1500 is essentially configured to divide that section into the most optimum packets to sort whether the evaluation of the packets is based on required qualities, relative values, or a combination of the foregoing.

As previously noted, embodiments of the present disclosure can result in the sorting out of materials that are not all of the same classification but nevertheless in a satisfactory manner so long as a required quality threshold is adhered to. With respect to the foregoing example, the selected packet 1403 is composed of four “53” segments and one “52” segment. Referring to FIG. 13, there are two 5xx3 alloy pieces and one 5xx2 alloy piece associated with these segments. Thus, the 5xx2 alloy piece will be sorted out along with the two 5xx3 alloy pieces. However, this is predetermined by the user as acceptable since the combination of the classified segments within the selected packet meet the required quality threshold. Likewise, the selected packet 1406 is composed of four “62” segments and one “52” segment. Referring to FIG. 13, there is one relatively large 6xx2 alloy piece and one 5xx2 alloy piece associated with these segments. Thus, the 5xx2 alloy piece will be sorted out along with the 6xx2 alloy piece. However, this is predetermined by the user as acceptable since the combination of the classified segments within the selected packet meet the required quality threshold.

It will be appreciated by those skilled in the art that the sorting devices may not be able to completely sort certain material pieces from the conveyor belt that are associated with one or more segments of a packet should such segments make up a small end portion of a large material piece due to the large piece not being positioned in sufficient proximity to the sorting device (e.g., an air nozzle only blows on an end of a large material piece). For example, the packet 1406 includes the “63” segment, which may be a part of a large material piece (e.g., see the material piece 1306 in FIG. 13) that has segments that are not within the packet 1406.

It can be readily appreciated that various embodiments of the system and process 1500 may result in some material pieces that will not get sorted (i.e., unsorted) (e.g., because there will be packets that do not meet the minimum required quality, such as the aforementioned packets 1401, 1404, and 1405). For example, the rightmost 5xx2 material piece in the section shown in FIG. 13 will go unsorted because it corresponds to both of the unselected packets 1401 and 1402; the leftmost 6xx3 material piece in the section will go unsorted because it corresponds to a segment that does not pertain to a selected packet; and possibly the 6xx3 piece 1306 will go unsorted because a large portion of the piece corresponds to segments that were part of unselected packets 1404 and 1405. Nevertheless, it is possible that rerunning these unsorted packets through the classifying/sorting system 1200 may still provide a significant increase in throughput over sorting processes that position/deposit material pieces with irregular or even regular spacing.

In accordance with alternative embodiments of the present disclosure, segments may be classified/evaluated in order to achieve a predetermined aggregate composition within one or more of the receptacles. Depending upon the specific requirements of the predetermined specific aggregate chemical composition, multiple different segment classifications/evaluations may be mapped to a single sorting device and associated receptacle. In other words, there need not be a one-to-one correlation between classifications and receptacles. For example, it may be desired by the user to sort certain classifications of materials into the same receptacle in order to achieve a particular aggregate chemical composition. To accomplish this sort, when a material segment is classified as meeting one or more requirements for achieving the particular aggregate chemical composition, the same sorting device may be activated to sort these into the same receptacle. Such combination sorting may be applied to produce any desired combination of sorted material pieces (e.g., one or more particular aggregate chemical compositions). The mapping of classifications may be programmed by the user to produce such desired combinations. Additionally, the classifications of material pieces are user-definable, and not limited to any particular known classifications of material pieces.

In accordance with certain embodiments of the present disclosure, the classifying/sorting system 1200 may be configured to output a collection of sorted materials that in the aggregate possesses a specific chemical composition (i.e., a predetermined specific aggregate chemical composition). As an example, within certain embodiments of the present disclosure, material pieces may be sorted into a separate receptacle or receptacles in order to separate material pieces composed of a specific chemical composition, or compositions, from other material pieces composed of a different specific chemical composition in order to produce a predetermined specific aggregate chemical composition within the group or collection of sorted material pieces. In a non-limiting example, a collection of materials composed of various aluminum alloys (e.g., various different wrought and/or cast aluminum alloys) may be sorted in accordance with embodiments of the present disclosure in order to produce an aluminum alloy having a desired (predetermined) chemical composition (which may be an aluminum alloy having a unique chemical composition different from known aluminum alloys). As described with respect to FIG. 14, such a desired chemical composition may be a predetermined required quality (purity) of a particular aluminum alloy (e.g., in which the amount (by wt. %) or number of material pieces that has been sorted into a receptacle has a minimum percentage of that particular aluminum alloy (which, with respect to certain embodiments, may also be referred to herein as having a predetermined specific aggregate chemical composition)). In other words, if such a collection of sorted materials were, or at least theoretically could be, combined into a singular object or mass (e.g., melted together or mixed into a solution or melt), such a singular object or mass would then possess the specific chemical composition. Moreover, embodiments of the present disclosure can be configured to output a collection of materials possessing a specific chemical composition not present within any individual material piece fed into the classifying/sorting system 1200.

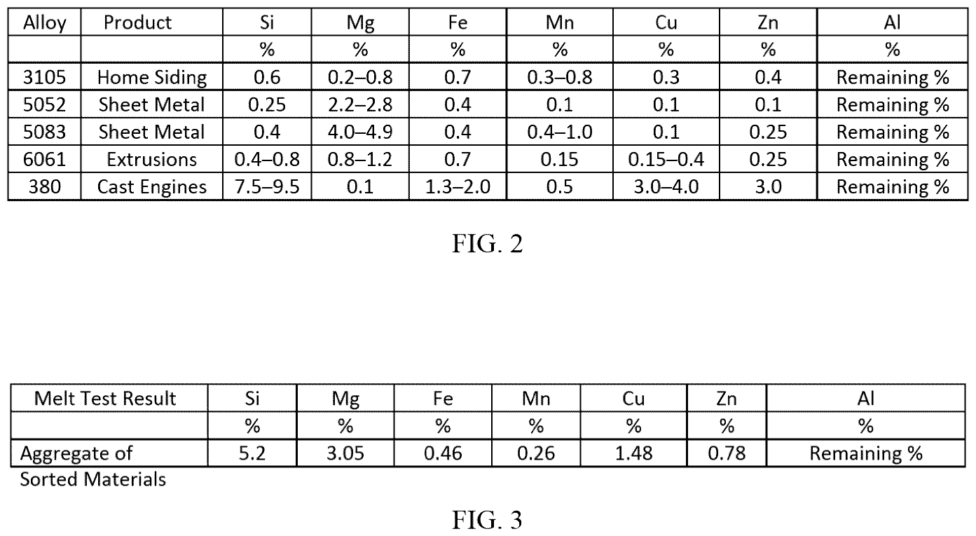

A non-limiting example would be the production of an aluminum alloy possessing a chemical composition according to a predetermined (e.g., as designed by the user of the classifying/sorting system 1200) combination of specific weight percentages (wt. %) of aluminum and selected alloying elements (e.g., silicon, magnesium, iron, manganese, copper, and/or zinc). The scrap pieces of aluminum alloys available to be positioned/deposited into the classifying/sorting system 1200 may be those listed in the table of FIG. 2. And, it may be desired to produce from a sorting of such available aluminum alloy scrap pieces an aluminum alloy possessing a chemical composition substantially equivalent to the one listed in the table of FIG. 3. However, even though the classifying/sorting system 1200 can be configured to distinguish between each of the aluminum alloys listed in the table of FIG. 2 (e.g., by classification of each of the segments of the aluminum alloy pieces 1201), none of these aluminum alloys possess a chemical composition equivalent to the chemical composition listed in the table of FIG. 3. Therefore, sorting out scrap pieces composed of any one of the aluminum alloys listed in the table of FIG. 2 would not result in a collection of aluminum alloy scrap pieces possessing, in the aggregate, a chemical composition equivalent to the chemical composition listed in the table of FIG. 3.

However, embodiments of the present disclosure can be configured to produce a collection of aluminum alloy scrap pieces possessing an aggregate chemical composition equivalent, or at least substantially equivalent, to the chemical composition listed in the table of FIG. 3. This is accomplished by utilizing embodiments of the present disclosure disclosed herein to classify, select, and sort for output a combination of a plurality of scrap pieces of the aluminum alloys of FIG. 2 in a ratio that results in the aggregate chemical composition (also referred to herein as the predetermined specific aggregate chemical composition).

Since the individual aluminum alloy scrap pieces may have different sizes, and thus different masses, the profilometers 1211A, 1211B of FIG. 12 may be utilized to estimate the mass for each aluminum alloy scrap piece. For example, the sizes of each of the scrap pieces may be utilized to determine (calculate) a mass, or at least an approximate mass, for each scrap piece. Since the classifying/sorting system 1200 has been configured to recognize and classify each scrap piece or segment(s) of each scrap piece, as the case may be, as belonging to one of the plurality of aluminum alloys listed in the table of FIG. 2, and since the specific chemical compositions for each of the different aluminum alloys are known, the classifying/sorting system 1200 can use this information along with the determined size for each scrap piece to determine (calculate) the mass, or at least the approximate mass, of each of the different chemical elements contained within each aluminum alloy scrap piece or segment of aluminum alloy scrap piece.

To produce a collection of the aluminum alloy scrap pieces possessing the aggregate chemical composition, the classifying/sorting system 1200 is configured to then classify and select for sorting those aluminum alloy scrap pieces that, when combined, achieve the aggregate chemical composition for the combined mass of the sorted aluminum alloy scrap pieces. In other words, if such a collection of aluminum alloy scrap pieces sorted and output by the classifying/sorting system 1200 were melted together (which they are likely to be at some point (e.g., by a secondary aluminum smelter)), the resultant melt would possess the aggregate chemical composition, or at least substantially close to the aggregate chemical composition within a desired threshold of accuracy.

Consequently, the classifying/sorting system 1200 may be configured to calculate on a running basis the contributions to the individual masses of each of the chemical elements within the aggregate chemical composition as each aluminum alloy scrap piece is added to the sorted-out collection so that the classifying/sorting system 1200 can then determine whether the next aluminum alloy scrap piece or packet of aluminum alloy scrap piece, as the case may be, that is evaluated should be added to the collection or not (i.e., sorted from the conveyor system).

FIG. 4 illustrates a flowchart block diagram of a system and process 400 configured in accordance with embodiments of the present disclosure for producing a collection of material pieces possessing a predetermined specific aggregate chemical composition. The system and process 400 may be implemented as a computer program (or other type of algorithm) performed within the classifying/sorting system 1200. The system and process 400 may be performed in conjunction with aspects of the system and process 3500 of FIG. 9, the system and process 1000 of FIG. 10, and/or the system and process 1500 of FIG. 15.

Though the system and process 400 is described with respect to utilizing within the classifying/sorting system 1200, the system and process 400 may be implemented within the material handling system 100 as well.

In the process block 401, the classifying/sorting system 1200 receives, or is input with, a predetermined specific aggregate chemical composition that is desired to be produced at the output of one of the sorting devices 1226A . . . 1229B. In the process block 402, as each material piece 1201 is conveyed past the profilometer 1211A, 1211B, it will determine the size and/or shape of each of the material pieces 1201 as described herein. In the process block 403, a classification is assigned to each segment of the material pieces 1201 by the vision system 1210A, 1210B and/or one or more of the sensor systems 1220A, 1220B in a manner as described herein. In the process block 404, the classifying/sorting system 1200 will determine the chemical composition corresponding to each segment of the material pieces 1201 based on the classification. This may be determined directly using one or more of the sensor systems 1220A, 1220B that are capable of measuring and determining the weight percentages of the various chemical elements within a particular material, such as an XRF or LIBS system. Or, the chemical composition of each segment of the material pieces 1201 may be determined indirectly, such as being inferred as a result of the classifications. For example, if the various different classes or types of the material pieces 1201 fed into the classifying/sorting system 1200 are known (e.g., as previously described with respect to FIG. 2), then the specific chemical compositions for each class or type of material may be input into the classifying/sorting system 1200 (e.g., and stored in a database), and then when a particular segment of a material piece 1201 is classified (e.g., by the vision system 1210A, 1210B), its specific chemical composition will be matched (associated in some manner) to its determined classification. Additionally, in the process block 404, the mass associated with each segment of the material pieces 1201 may be approximately calculated based on the previously determined size and/or shape, and consequently, the approximate masses of each chemical element in the material pieces can be determined. This can be accomplished since the relative masses of the chemical elements of various known types or classes of materials will be known and can be previously input into the classifying/sorting system 1200 in a similar manner as the known chemical compositions.

In the process block 405, the classifying/sorting system 1200 will sort the material pieces 1201 (e.g., in packets as described herein) based on the determined chemical compositions and masses so as to achieve the predetermined specific aggregate chemical composition. For example, the classifying/sorting system 1200 may be configured to sort (e.g., divert) selected material pieces 1201 into a predetermined receptacle by a predetermined sorting device. The remainder of the material pieces 1201 may be collected into an “unsorted” receptacle, or the classifying/sorting system 1200 may be configured to sort certain ones of the material pieces 1201 into another receptacle to achieve a second (e.g., different) predetermined specific aggregate chemical composition. Alternatively, the classifying/sorting system 1200 may be configured to sort the remaining material pieces 1201 based on any other type of desired classification(s), such as sorting the remaining material pieces 1201 into two different classifications (e.g., wrought, extruded, and/or cast aluminum). In the process block 406, the sorted material pieces 1201 for achieving the specific aggregate chemical composition are collected into the predetermined receptacle.

The process blocks 402-406 may be repeated as needed to achieve the specific aggregate chemical composition, to achieve the specific aggregate chemical composition within a specified threshold of accuracy, or to achieve the specific aggregate chemical composition for a desired (predetermined) collected mass of materials (as may be determined by counting the number of materials diverted into the receptacle). For example, as each material piece is sorted, the system may continually determine (i.e., update) the aggregate chemical composition of the then collected material pieces, and will then continue the sorting until the updated aggregate chemical composition is within a threshold level of the predetermined specific aggregate chemical composition, which may also take into account predetermined threshold qualities and/or relative values as described with respect to FIGS. 14-15. As each material segment is classified, the classifying/sorting system 1200 will determine whether to divert the corresponding material piece(s) to join the collection, such as whether the corresponding material piece(s) would increase or decrease the aggregate weight percentage of a specific chemical element within the already sorted and collected material pieces. Additionally, the classifying/sorting system 1200 may be configured to not divert certain material pieces into the collection because such material pieces contain a contaminant that is not desired to be included within the predetermined specific chemical composition (e.g., a wrought aluminum alloy piece that contains an iron-containing material such as a bolt). Alternatively, other systems may be implemented in order to remove material pieces that contain a particular contaminant.

If it can be assumed that a sufficient majority of the material pieces are all of about the same size and mass, then such implementations for determining the mass of each piece can be omitted.

In accordance with alternative embodiments of the present disclosure, the receptacle that is collecting the diverted material pieces could be positioned on a weight scale that continually weighs the collected material pieces, thus providing an approximate weight and resultant mass for each material piece as it is sorted and collected within the receptacle. These masses can them be utilized in the system and process 400 as described herein.

In accordance with certain embodiments of the present disclosure, a plurality of at least a portion of the material handling system 100 and/or the classifying/sorting system 1200 may be linked together in succession in order to perform multiple iterations or layers of sorting. For example, when two or more systems are linked in such a manner, the conveyor system may be implemented with a single conveyor belt, or multiple conveyor belts, conveying the material pieces past a first vision system (and, in accordance with certain embodiments, a sensor system) configured for sorting material pieces of a first set of a mixture of materials by a sorter into a first set of one or more receptacles, and then conveying the material pieces past a second vision system (and, in accordance with certain embodiments, another sensor system) configured for sorting material pieces of a second set of a mixture of materials by a second sorter into a second set of one or more sorting receptacles. A further discussion of such multistage sorting is in U.S. Pat. No. 11,278,937, which is hereby incorporated by reference herein.

Such successions of systems can contain any number of such systems linked together in such a manner. In accordance with certain embodiments of the present disclosure, each successive vision system or sensor system may be configured to sort out a different material than previous vision system(s) or sensor system(s) with the end result producing a collection of material pieces possessing the predetermined specific aggregate chemical composition.

With reference now to FIG. 11, a block diagram illustrating a data processing (“computer”) system 3400 is depicted in which aspects of embodiments of the disclosure may be implemented. (The terms “computer,” “system,” “computer system,” and “data processing system” may be used interchangeably herein.) The computer system 107, the automation control system 108, aspects of the sensor systems 1220A, 1220B, and/or the vision systems 1210A, 1210B may be configured similarly as the computer system 3400. The computer system 3400 may employ a local bus 3405. Any suitable bus architecture may be utilized such as a peripheral component interconnect (“PCI”) local bus architecture, Accelerated Graphics Port (“AGP”) architecture, or Industry Standard Architecture (“ISA”), among others. One or more processors 3415, volatile memory 3420, and non-volatile memory 3435 may be connected to the local bus 3405 (e.g., through a PCI Bridge (not shown)). An integrated memory controller and cache memory may be coupled to the one or more processors 3415. The one or more processors 3415 may include one or more central processor units and/or one or more graphics processor units 3401 and/or one or more tensor processing units. Additional connections to the local bus 3405 may be made through direct component interconnection or through add-in boards. In the depicted example, a communication (e.g., network (LAN)) adapter 3425, an I/O (e.g., small computer system interface (“SCSI”) host bus) adapter 3430, and expansion bus interface (not shown) may be connected to the local bus 3405 by direct component connection. An audio adapter (not shown), a graphics adapter (not shown), and display adapter 3416 (coupled to a display 3440) may be connected to the local bus 3405 (e.g., by add-in boards inserted into expansion slots). The user interface adapter 3412 may provide a connection for a keyboard 3413 and a mouse 3414, modem (not shown), and additional memory (not shown). The I/O adapter 3430 may provide a connection for a hard disk drive 3431, a solid-state drive 3432, and a CD-ROM drive (not shown).

An operating system may be run on the one or more processors 3415 and used to coordinate and provide control of various components within the computer system 3400. In FIG. 11, the operating system may be a commercially available operating system. An object-oriented programming system (e.g., Java, Python, etc.) may run in conjunction with the operating system and provide calls to the operating system from programs or programs (e.g., Java, Python, etc.) executing on the system 3400. Instructions for the operating system, the object-oriented operating system, and programs may be located on non-volatile memory 3435 storage devices, such as a hard disk drive 3431 or solid state drive 3432, and may be loaded into volatile memory 3420 for execution by the processor 3415.

Those of ordinary skill in the art will appreciate that the hardware in FIG. 11 may vary depending on the implementation. Other internal hardware or peripheral devices, such as flash ROM (or equivalent nonvolatile memory) or optical disk drives and the like, may be used in addition to or in place of the hardware depicted in FIG. 11. Also, any of the processes of the present disclosure may be applied to a multiprocessor computer system, or performed by a plurality of such systems 3400. For example, training of a machine learning system may be performed by a first computer system 3400, while operation of the material handling system 100 or the classifying/sorting system 1200 for sorting may be performed by a second computer system 3400.

As another example, the computer system 3400 may be a stand-alone system configured to be bootable without relying on some type of network communication interface, whether or not the computer system 3400 includes some type of network communication interface. As a further example, the computer system 3400 may be an embedded controller, which is configured with ROM and/or flash ROM providing non-volatile memory storing operating system files or user-generated data.

The depicted example in FIG. 11 and above-described examples are not meant to imply architectural limitations. Further, a computer program form of aspects of the present disclosure may reside on any computer readable storage medium (i.e., floppy disk, compact disk, hard disk, tape, ROM, RAM, etc.) used by a computer system.

As has been described herein, embodiments of the present disclosure may be implemented to perform the various functions described for identifying, tracking, classifying, and/or sorting material pieces. Such functionalities may be implemented within hardware and/or software, such as within one or more data processing systems (e.g., the data processing system 3400 of FIG. 11), such as the previously noted computer system 107, the vision systems 1210A, 1210B, aspects of the sensor systems 1220A, 1220B, and/or the automation control system 108. Nevertheless, the functionalities described herein are not to be limited for implementation into any particular hardware/software platform.

In accordance with various embodiments of the present disclosure, different types or classes of materials may be classified by different types of sensors each for use with an AI system, and combined to classify materials in a stream of scrap or waste.

In accordance with various embodiments of the present disclosure, data (e.g., spectral data) from two or more sensors can be combined using a single or multiple AI systems to perform classifications of materials.

In accordance with various embodiments of the present disclosure, multiple sensor systems can be mounted onto a single conveyor system, with each sensor system utilizing a different AI system. In accordance with various embodiments of the present disclosure, multiple sensor systems can be mounted onto different conveyor systems, with each sensor system utilizing a different AI system.

As will be appreciated by one skilled in the art, aspects of the present disclosure may be embodied as a system, process, method, and/or computer program product. Accordingly, various aspects of the present disclosure may take the form of an entirely hardware embodiment, an entirely software embodiment (including firmware, resident software, micro-code, etc.), or embodiments combining software and hardware aspects, which may generally be referred to herein as a “circuit,” “circuitry,” “module,” or “system.” Furthermore, aspects of the present disclosure may take the form of a computer program product embodied in one or more computer readable storage medium(s) having computer readable program code embodied thereon. (However, any combination of one or more computer readable medium(s) may be utilized. The computer readable medium may be a computer readable signal medium or a computer readable storage medium.)

A computer readable storage medium may be, for example, but not limited to, an electronic, magnetic, optical, electromagnetic, infrared, biologic, atomic, or semiconductor system, apparatus, controller, or device, or any suitable combination of the foregoing, wherein the computer readable storage medium is not a transitory signal per se. More specific examples (a non-exhaustive list) of the computer readable storage medium may include the following: an electrical connection having one or more wires, a portable computer diskette, a hard disk, a solid state memory, a random access memory (“RAM”) (e.g., RAM 3420 of FIG. 11), a read-only memory (“ROM”) (e.g., ROM 3435 of FIG. 11), an erasable programmable read-only memory (“EPROM” or flash memory), an optical fiber, a portable compact disc read-only memory (“CD-ROM”), an optical storage device, a magnetic storage device (e.g., hard drive 3431 of FIG. 11), or any suitable combination of the foregoing. In the context of this document, a computer readable storage medium may be any tangible medium that can contain or store a program for use by or in connection with an instruction execution system, apparatus, controller, or device. Program code embodied on a computer readable signal medium may be transmitted using any appropriate medium, including but not limited to wireless, wire line, optical fiber cable, RF, etc., or any suitable combination of the foregoing.

A computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, controller, or device.

The flowchart and block diagrams in the figures illustrate architecture, functionality, and operation of possible implementations of systems, methods, processes, and computer program products according to various embodiments of the present disclosure. In this regard, each block in the flowcharts or block diagrams may represent a module, segment, or portion of code that includes one or more executable program instructions for implementing the specified logical function(s). It should also be noted that, in some implementations, the functions noted in the blocks may occur out of the order noted in the figures. For example, two blocks shown in succession may, in fact, be executed substantially concurrently, or the blocks may sometimes be executed in the reverse order, depending upon the functionality involved.

In the description herein, a flow-charted technique may be described in a series of sequential actions. The sequence of the actions, and the party performing the actions, may be freely changed without departing from the scope of the teachings. Actions may be added, deleted, or altered in several ways. Similarly, the actions may be re-ordered or looped. Further, although processes, methods, algorithms, or the like may be described in a sequential order, such processes, methods, algorithms, or any combination thereof may be operable to be performed in alternative orders. Further, some actions within a process, method, or algorithm may be performed simultaneously during at least a point in time (e.g., actions performed in parallel), can also be performed in whole, in part, or any combination thereof.

Modules implemented in software for execution by various types of processors (e.g., GPU 3401, CPU 3415) may, for instance, include one or more physical or logical blocks of computer instructions, which may, for instance, be organized as an object, procedure, or function. Nevertheless, the executables of an identified module need not be physically located together, but may include disparate instructions stored in different locations that when joined logically together, include the module and achieve the stated purpose for the module. Indeed, a module of executable code may be a single instruction, or many instructions, and may even be distributed over several different code segments, among different programs, and across several memory devices. Similarly, operational data (e.g., material classification libraries described herein) may be identified and illustrated herein within modules, and may be embodied in any suitable form and organized within any suitable type of data structure. The operational data may be collected as a single data set, or may be distributed over different locations including over different storage devices. The data may provide electronic signals on a system or network.

These program instructions may be provided to one or more processors and/or controller(s) of a general purpose computer, special purpose computer, or other programmable data processing apparatus (e.g., controller) to produce a machine, such that the instructions, which execute via the processor(s) (e.g., GPU 3401, CPU 3415) of the computer or other programmable data processing apparatus, create circuitry or means for implementing the functions/acts specified in the flowchart and/or block diagram block or blocks.

It will also be noted that each block of the block diagrams and/or flowchart illustrations, and combinations of blocks in the block diagrams and/or flowchart illustrations, can be implemented by special purpose hardware-based systems (e.g., which may include one or more graphics processing units (e.g., GPU 3401)) that perform the specified functions or acts, or combinations of special purpose hardware and computer instructions. For example, a module may be implemented as a hardware circuit including custom VLSI circuits or gate arrays, off-the-shelf semiconductors such as logic chips, transistors, controllers, or other discrete components. A module may also be implemented in programmable hardware devices, such as field programmable gate arrays, programmable array logic, programmable logic devices, or the like.

Computer program code, i.e., instructions, for carrying out operations for aspects of the present disclosure may be written in any combination of one or more programming languages, including an object oriented programming language such as Java, Smalltalk, Python, C++, or the like, conventional procedural programming languages, such as the “C” programming language or similar programming languages, or any of the AI software disclosed herein. The program code may execute entirely on the user's computer system, partly on the user's computer system, as a stand-alone software package, partly on the user's computer system (e.g., the computer system utilized for sorting) and partly on a remote computer system (e.g., the computer system utilized to train the sensor system), or entirely on the remote computer system or server. In the latter scenario, the remote computer system may be connected to the user's computer system through any type of network, including a local area network (“LAN”) or a wide area network (“WAN”), or the connection may be made to an external computer system (for example, through the Internet using an Internet Service Provider).

These program instructions may also be stored in a computer readable storage medium that can direct a computer system, other programmable data processing apparatus, controller, or other devices to function in a particular manner, such that the instructions stored in the computer readable medium produce an article of manufacture including instructions which implement the function/act specified in the flowchart and/or block diagram block or blocks.

One or more databases may be included in a host for storing and providing access to data for the various implementations. One skilled in the art will also appreciate that, for security reasons, any databases, systems, or components of the present disclosure may include any combination of databases or components at a single location or at multiple locations, wherein each database or system may include any of various suitable security features, such as firewalls, access codes, encryption, de-encryption and the like. The database may be any type of database, such as relational, hierarchical, object-oriented, and/or the like. Common database products that may be used to implement the databases include DB2 by IBM, any of the database products available from Oracle Corporation, Microsoft Access by Microsoft Corporation, or any other database product. The database may be organized in any suitable manner, including as data tables or lookup tables.

Association of certain data (e.g., between a classified material and its known chemical composition, or between a classified material and its calculated approximate mass) may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In these embodiments, the data corresponding to the key field in each of the merged data tables is preferably the same. However, data tables having similar, though not identical, data in the key fields may also be merged by using AGREP, for example.

Reference is made herein to “configuring” a device or a device “configured to” perform some function. It should be understood that this may include selecting predefined logic blocks and logically associating them, such that they provide particular logic functions, which includes monitoring or control functions. It may also include programming computer software-based logic of a control device, wiring discrete hardware components, or a combination of any or all of the foregoing.

In the descriptions herein, numerous specific details are provided, such as examples of programming, software modules, user selections, network transactions, database queries, database structures, hardware modules, hardware circuits, hardware chips, controllers, etc., to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations may be not shown or described in detail to avoid obscuring aspects of the disclosure.

Those of skill in the art should appreciate that the various settings and parameters (including the neural network parameters) of the components of the material handling system 100 or the classifying/sorting system 1200 may be customized, optimized, and reconfigured over time based on the types of materials being classified and sorted, the desired classification and sorting results, the type of equipment being used, empirical results from previous classifications, data that becomes available, and other factors.

Reference throughout this specification to “an embodiment,” “embodiments,” or similar language means that a particular feature, structure, or characteristic described in connection with the embodiments is included in at least one embodiment of the present disclosure. Thus, appearances of the phrases “in one embodiment,” “in an embodiment,” “embodiments,” “certain embodiments,” “various embodiments,” and similar language throughout this specification may, but do not necessarily, all refer to the same embodiment. Furthermore, the described features, structures, aspects, and/or characteristics of the disclosure may be combined in any suitable manner in one or more embodiments. Correspondingly, even if features may be initially claimed as acting in certain combinations, one or more features from a claimed combination can in some cases be excised from the combination, and the claimed combination can be directed to a sub-combination or variation of a sub-combination.

Benefits, advantages, and solutions to problems may have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims. Further, no component described herein is required for the practice of the disclosure unless expressly described as essential or critical.

While this specification contains many specifics, these should not be construed as limitations on the scope of the disclosure or of what can be claimed, but rather as descriptions of features specific to particular implementations of the disclosure. Headings herein may be not intended to limit the disclosure, embodiments of the disclosure or other matter disclosed under the headings.

Herein, the term “or” may be intended to be inclusive, wherein “A or B” includes A or B and also includes both A and B. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The terminology used herein is for the purpose of describing particular embodiments only and is not intended to be limiting of the disclosure. As used herein, the singular forms “a,” “an,” and “the” may be intended to include the plural forms as well, unless the context clearly indicates otherwise.

The corresponding structures, materials, acts, and equivalents of all means or step plus function elements in the claims below may be intended to include any structure, material, or act for performing the function in combination with other claimed elements as specifically claimed.

As used herein, terms such as “controller,” “processor,” “memory,” “neural network,” “interface,” “sorter,” “sorting apparatus,” “sorting device,” “device,” “pushing mechanism,” “pusher devices,” “imaging sensor,” “bin,” “receptacle,” “system,” and “circuitry” each refer to non-generic device elements that would be recognized and understood by those of skill in the art and are not used herein as nonce words or nonce terms for the purpose of invoking 35 U.S.C. 112(f).

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, exemplary fractions, and/or materials may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary.

Unless defined otherwise, all technical and scientific terms (such as acronyms used for chemical elements within the periodic table) used herein have the same meaning as commonly understood to one of ordinary skill in the art to which the presently disclosed subject matter belongs. All publications, patent applications, patents, and other references mentioned herein are incorporated by reference in their entirety, unless a particular passage is cited. In case of conflict, the present specification, including definitions, will control. In addition, the materials, methods, and examples are illustrative only, and not intended to be limiting.

To the extent not described herein, many details regarding specific materials, processing acts, and circuits are conventional, and may be found in textbooks and other sources within the computing, electronics, and software arts.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter. As used herein, the terms “about” or “approximately” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method. As used herein, the term “similar” may refer to values that are within a particular offset or percentage of each other (e.g., 1%, 2%, 5%, 10%, etc.).

What is claimed is:

1. A method for handling material pieces, the method comprising:
positioning the material pieces onto a conveyor system in a contiguous stream along a line in a direction of travel of the conveyor system;
performing sensor system measurements of material corresponding to each segment of the contiguous stream of material pieces so that separate sensor system measurements are collected from materials within each of two successive segments within the contiguous stream;
classifying the material corresponding to each segment as belonging to one of a plurality of different material classifications;
determining a relative quality of each classified material contained within a packet, wherein the packet is composed of M number of consecutive segments, wherein M>1; and
determining whether to sort from the conveyor system the material pieces corresponding to the packet as a function of the classifications of the material corresponding to each segment and the determined relative quality of each classified material contained within the packet.

2. The method as recited in claim 1, further comprising measuring an amount of material corresponding to each segment, wherein the relative quality is determined from the measured amount of material corresponding to each segment within the packet.

3. The method as recited in claim 1, wherein a section of the contiguous stream of material pieces is composed of N number of segments corresponding to the material pieces deposited onto the conveyor system, wherein N>M>1, the method further comprising sorting from the conveyor system the material pieces corresponding to the packet when the determined relative quality of at least one classified material contained within the packet exceeds a predetermined quality threshold.

4. The method as recited in claim 3, wherein the predetermined quality threshold is a calculated percentage of a specific material within the packet that exceeds a predetermined threshold quantity for one of the material classifications.

5. The method as recited in claim 1, wherein the material pieces have different sizes and shapes, and wherein lengths of each segment are less than an entire span of at least one of the material pieces measured along the line in a direction of travel of the conveyor system, and wherein at least one of the material pieces within the contiguous stream corresponds to at least two successive segments.

6. The method as recited in claim 1, wherein a first segment within the packet is determined to have a different material classification from a second segment within the packet, further comprising sorting the material pieces corresponding to the packet from the conveyor system together as a group.

7. The method is recited in claim 1, further comprising assigning predetermined relative values to each segment in the packet as a function of its classification, wherein the determination whether to sort from the conveyor system the material pieces corresponding to the packet is performed as a function of the classifications of the material corresponding to each segment, the determined relative quality of each classified material contained within the packet, and the assigned predetermined relative values for each segment.

8. The method as recited in claim 1, wherein a length of each segment is predetermined based on timing of predetermined intervals set for performing the sensor system measurements on each segment and a speed of the moving conveyor belt, wherein the lengths of the segments are equal.

9. The method as recited in claim 1, wherein the positioning comprises singulating the material pieces to produce the contiguous stream of material pieces wherein spacing between consecutively deposited material pieces is no greater than a predetermined distance.

10. The method as recited in claim 1, wherein the classification is based on a chemical composition of the material determined by the sensor system measurements.

11. The method as recited in claim 2, wherein a section of the contiguous stream of material pieces is composed of N number of segments corresponding to the material pieces positioned onto the conveyor system, wherein N>M>1, the method further comprising:
assigning a predetermined relative value to each segment as a function of its classification and determined relative quality, whereby different material classifications have been predetermined with different relative values;
determining which packets within the section have a relative quality of at least one classified material contained within the packet that exceeds a predetermined quality threshold;
calculating a score for each of the packets that is based on the assigned relative value of each segment within the packet; and
sending sorting decisions to one or more sorting devices as a function of the calculated scores for each of the packets.

12. The method as recited in claim 11, further comprising sorting from the conveyor system as a combined group the material pieces corresponding to a first one of the packets that has been calculated with a highest score among the packets.

13. The method as recited in claim 11, wherein the material pieces are mixed metal scrap pieces.

14. A system for handling material pieces positioned onto a moving conveyor system in a contiguous stream along a line in a direction of travel of the moving conveyor system, the system comprising:
one or more sensor systems configured to perform sensor system measurements of material corresponding to each segment of the contiguous stream of material pieces so that separate sensor system measurements are collected from materials within each of two successive segments within the contiguous stream;
circuitry configured to classify the material corresponding to each segment as belonging to one of a plurality of different material classifications;
circuitry configured to determine a relative quality of each classified material contained within a packet, wherein the packet is composed of M number of consecutive segments, wherein M>1; and
circuitry configured to determine whether to sort from the moving conveyor system the material pieces corresponding to the packet as a function of the classifications of the material corresponding to each segment and the determined relative quality of each classified material contained within the packet.

15. The system as recited in claim 14, further comprising an apparatus configured to measure an amount of material corresponding to each segment, wherein the relative quality is determined from the measured amount of material corresponding to each segment within the packet.

16. The system as recited in claim 14, wherein a section of the contiguous stream of material pieces is composed of N number of segments corresponding to the material pieces deposited onto the moving conveyor system, wherein N>M>1, wherein the material pieces have different sizes and shapes, and wherein lengths of each segment are less than an entire span of at least one of the material pieces measured along the line in a direction of travel of the moving conveyor system, and wherein at least one of the material pieces within the contiguous stream corresponds to at least two successive segments, the system further comprising a sorting device configured to sort from the moving conveyor system the material pieces corresponding to the packet when the determined relative quality of at least one classified material contained within the packet exceeds a predetermined quality threshold, wherein the predetermined quality threshold is a calculated percentage of a specific material within the packet that exceeds a predetermined threshold quantity for one of the material classifications.

17. The system as recited in claim 16, wherein the material pieces are mixed aluminum alloy scrap pieces, wherein a first segment within the packet is determined to have a different material classification from a second segment within the packet, wherein the material pieces corresponding to the packet are sorted from the moving conveyor system together as a group.

18. The system as recited in claim 14, further comprising circuitry configured to assign predetermined relative values to each segment in the packet as a function of its classification, wherein the circuitry configured to determine whether to sort from the moving conveyor system the material pieces corresponding to the packet is performed as a function of the classifications of the material corresponding to each segment, the determined relative quality of each classified material contained within the packet, and the assigned predetermined relative values for each segment.

19. The system as recited in claim 14, wherein a section of the contiguous stream of material pieces is composed of N number of segments corresponding to the material pieces positioned onto the moving conveyor system, wherein N>M>1, the system further comprising:
circuitry configured to assign a predetermined relative value to each segment as a function of its classification and determined relative quality, whereby different material classifications have been predetermined with different relative values;
circuitry configured to determine which packets within the section have a relative quality of at least one classified material contained within the packet that exceeds a predetermined quality threshold;
circuitry configured to calculate a score for each of the packets that is based on the assigned relative value of each segment within the packet; and
circuitry configured to send sorting decisions to one or more sorting devices as a function of the calculated scores for each of the packets.

20. The system as recited in claim 19, further comprising a first one of the one or more sorting devices configured to sort from the moving conveyor system as a combined group the material pieces corresponding to a first one of the packets that has been calculated with a highest score among the packets.
